(19) United States
(12) Patent Application Publication
(10) Pub. No.: US 2024/0328669 A1
(43) Pub. Date: Oct. 3, 2024

(54) HEATER ELEMENT ASSEMBLY

(71) Applicant: NGK INSULATORS, LTD., Nagoya-City (JP)

(72) Inventors: Yukio MIYAIRI, Nagoya-Shi (JP); Yoshiki KONNO, Tajimi-Shi (JP)

(73) Assignee: NGK INSULATORS, LTD., Nagoya-City (JP)

(21) Appl. No.: 18/603,367

(22) Filed: Mar. 13, 2024

(30) Foreign Application Priority Data
Mar. 30, 2023 (JP) 2023-056760

(51) Int. Cl. F24H 3/00

(52) U.S. Cl. CPC F24H 3/002

(57) ABSTRACT

A heater element assembly includes a heater element, a cushioning material, and a frame body, the heater element includes: a honeycomb structure portion capable of generating heat when energized; a first electrode layer that covers a part or all of a surface of the partition walls forming the first end surface; a second electrode layer that covers a part or all of a surface of the partition walls forming the second end surface; a first terminal connected to an outer surface of the first electrode layer; and a second terminal connected to an outer surface of the second electrode layer; wherein the frame body includes a first frame portion which is made of resin and has an inner peripheral surface that fits with an outer peripheral surface of the outer peripheral wall of the honeycomb structure portion via the cushioning material.

### CROSS REFERENCE TO RELATED APPLICATIONS

The present invention claims the benefit of priority to Japanese Patent Application No. 2023-56760 filed on Mar. 30, 2023 with the Japanese Patent Office, the entire contents of which are incorporated herein by reference in its entirety.

### FIELD OF THE INVENTION

The present invention relates to a heater element assembly including a heater element and a frame body.

### BACKGROUND OF THE INVENTION

For various vehicles such as automobiles, there is an increasing demand for improvement of the vehicle interior environment. Specific requirements include reducing CO₂ in the vehicle interior to suppress driver drowsiness, controlling the humidity in the vehicle interior, and reducing harmful volatile components such as odor components and allergy-inducing components within the vehicle interior, and the like. As an effective measure to meet these demands, ventilation can be mentioned, but ventilation causes a large loss of heater energy in the winter, leading to a deterioration of energy efficiency in the winter. In particular, battery electric vehicles (BEVs) have a problem in that their cruising distance is significantly reduced due to energy loss.

Accordingly, in Patent Literature 1 and Patent Literature 2, there are disclosed vehicle interior purification systems which capture components to be removed such as water vapor and CO₂ in the air inside the vehicle interior with functional materials such as adsorbents, and then react or release these components to be removed by heating and discharge them outside the vehicle interior to regenerate the functional material. In such a vehicle interior purification system, in order to ensure the ability to capture the components to be removed, it is required that the contact between the air and the functional material is as much as possible, and the functional material can be heated to a predetermined temperature to promote the regeneration of the functional material. The regeneration is carried out, for example, by a method in which the substance adsorbed on the functional material is removed by an oxidation reaction, or by a method in which the substance adsorbed in the functional material is desorbed and discharged, but in either case, depending on the adsorbed substance, it is necessary to heat the functional material to an appropriate temperature.

As a heating method, vapor compression heat pumps are excellent in terms of thermal efficiency. However, vapor compression heat pumps have problems such as difficulty in operating when the outside air is extremely cold and difficulty in rapidly warming the passenger compartment when the vehicle is started. Therefore, it is considered to be practical to use a heater element that uses Joule heat as an auxiliary tool when rapid heating is required when starting the vehicle or when the outside temperature is extremely low, while using a vapor compression heat pump as the main heating device.

However, heater elements that utilize Joule heat tend to be large in size and take up space inside the vehicle. Therefore, it would be desirable to provide a more compact heater element. In this regard, it is known that a heater element having a honeycomb structure portion having PTC characteristics is advantageous because it can increase the heat transfer area per unit volume and prevent excessive heat generation (Patent Literature 3).

In Patent Literature 3, there is described a heater element comprising pillar-shaped honeycomb structure portion, the pillar-shaped honeycomb structure portion having an outer peripheral side wall; and partition walls having PTC characteristics that are disposed inside the outer peripheral side wall and partition a plurality of cells forming a flow path from a first end surface to the second end surface. Patent Literature 3 also describes that a pair of electrodes are joined to a heater element and then a voltage is applied between the pair of electrodes to generate heat.

Further, Patent Literature 4 discloses a heat generating device characterized in that all or a part of its heater element is made of positive characteristic porcelain having a large number of through holes, and the through holes are provided with means for causing gas or liquid to convect. It is also described that positive characteristic porcelain (PTCR) and a fan are placed opposite each other in a cylindrical frame, and that the PTCR is fixed to the frame with a heat-resistant insulative support.

### PRIOR ART

### Patent Literature

[Patent Literature 1] Japanese Patent Application Publication No. 2020-104774
[Patent Literature 2] Japanese Patent Application Publication No. 2020-111282
[Patent Literature 3] WO 2020/036067
[Patent Literature 4] Japanese Patent Application Publication No. S49-114130

### SUMMARY OF THE INVENTION

When a heater element including a honeycomb structure portion having PTC characteristics is installed in a vehicle, it is assumed that it is installed in a ventilation path in the HVAC, which is the vehicle's air conditioning system. In this case, it is considered preferable to install the heater element in a state where it is protected by a frame body. Regarding this point, although Patent Literature 4 describes that the PTCR is fixed to a frame with a heat-resistant insulative support, the study is insufficient from the viewpoint of protecting the PTCR and reducing heat loss.

The present invention has been created in view of the above circumstances, and in one embodiment, an object of the present invention is to provide a heater element assembly comprising a heater element comprising a honeycomb structure portion having PTC characteristics and a frame body, which has excellent protection performance for the heater element and also contributes to reducing heat loss and thermal stress.

The inventors of the present invention have conducted extensive studies to solve the above problems, and have found that it is advantageous to protect a heater element, which comprises a honeycomb structure portion with PTC characteristics, from the outer peripheral surface side with a resin frame body via a cushioning material. The present invention, which has been completed based on this finding, is exemplified as follows.
[1]

A heater element assembly, comprising a heater element, a cushioning material, and a frame body, the heater element comprising:
a honeycomb structure portion capable of generating heat when energized, comprising an outer peripheral wall; and partition walls disposed on an inner peripheral side of the outer peripheral wall partitioning a plurality of cells which form flow paths extending from a first end surface to a second end surface, the partition walls comprising a material having PTC characteristics;
a first electrode layer that covers a part or all of a surface of the partition walls forming the first end surface;
a second electrode layer that covers a part or all of a surface of the partition walls forming the second end surface;
a first terminal connected to an outer surface of the first electrode layer; and
a second terminal connected to an outer surface of the second electrode layer;
wherein the frame body comprises a first frame portion which is made of resin and has an inner peripheral surface that fits with an outer peripheral surface of the outer peripheral wall of the honeycomb structure portion via the cushioning material.
[2]

The heater element assembly according to [1], wherein the resin constituting the first frame portion has a Rockwell hardness of 150 HRR or less and/or 120 HRM or less as measured in accordance with ASTM D785-2008 R15.
[3]

The heater element assembly according to [1] or [2], wherein the resin constituting the first frame portion has a deflection temperature under load of 145° C. or higher as measured in accordance with JIS K7191-1:2015.
[4]

The heater element assembly according to any one of [1] to [3], wherein the resin constituting the first frame portion has a melting point of 250° C. or higher.
[5]

The heater element assembly according to any one of [1] to [4], wherein the resin constituting the first frame portion has a thermal conductivity of 0.5 W/m/K or less at 25° C. as measured in accordance with JIS R1611: 2010.
[6]

The heater element assembly according to any one of [1] to [5], wherein the resin constituting the first frame portion has a volume resistivity of 1.0×10¹⁶ Ω·cm or more at 25° C. as measured in accordance with JIS C2139: 2008.
[7]

The heater element assembly according to any one of [1] to [6], wherein the resin constituting the first frame portion comprises one or two selected from polyetheretherketone (PEEK) and polybutylene terephthalate (PBT).
[8]

The heater element assembly according to any one of [1] to [7], wherein a Young's modulus of the cushioning material is 0.05 to 0.3 MPa.
[9]

The heater element assembly according to any one of [1] to [8], wherein the cushioning material is made of silicone rubber sponge.
[10]

The heater element assembly according to any one of [1] to [9], wherein a thickness of the cushioning material in a compression direction is 0.5 to 5.0 mm.
[11]

The heater element assembly according to any one of [1] to [9], wherein the first end surface and the second end surface have an area of 50 to 150 cm².
[12]

The heater element assembly according to any one of [1] to [11], comprising:
a second frame portion made of resin that extends toward an inner peripheral side from an outer peripheral contour of the first end surface and surrounds at least a part of an outer peripheral portion of the first end surface; and
a third frame portion made of resin that extends toward an inner peripheral side of an outer peripheral contour of the second end surface and surrounds at least a part of an outer peripheral portion of the second end surface.
[13]

The heater element assembly according to [12], wherein
a width of an area where the second frame portion surrounds the first end surface is 10 mm or less, expressed as a length in a direction from the outer peripheral contour of the first end surface toward a center of gravity of the first end surface; and/or
a width of an area where the third frame portion surrounds the second end surface is 10 mm or less, expressed as a length in a direction from the outer peripheral contour of the second end surface toward a center of gravity of the second end surface.
[14]

The heater element assembly according to any one of [1] to [13], wherein the frame body is formed by connecting a pair of half-split members from a direction perpendicular to a direction in which the flow paths of the honeycomb structure portion extend.
[15]

The heater element assembly according to [14], wherein the pair of half-split members are connected by a fitting structure.
[16]

The heater element assembly according to any one of [1] to [15], wherein the frame body is formed by connecting a first tubular divisional portion made of resin and having the first frame portion, and a second tubular divisional portion made of resin and having an outer peripheral surface that is capable of fitting with an inner peripheral surface of the first tubular divisional portion, wherein the first tubular divisional portion and the second divisional portion are connected from a direction parallel to the direction in which the flow paths of the honeycomb structure portion extend.
[17]

The heater element assembly according to [16], wherein
the inner peripheral surface of the first tubular divisional portion comprises a first inner peripheral surface that fits with the outer peripheral surface of the outer peripheral wall of the honeycomb structure portion via the cushioning material; a second inner peripheral surface that is connected to one end of the first inner peripheral surface, a diameter of the second inner peripheral surface increasing as a distance from the one end of the first inner peripheral surface increases; and a third inner peripheral surface connected to one end of the second inner peripheral surface, a diameter of the third inner peripheral surface decreasing as a distance from the one end of the second inner peripheral surface increases; and
the outer peripheral surface of the second tubular divisional portion comprises a first outer peripheral surface that fits with the second inner peripheral surface and a second outer peripheral surface that fits with the third inner peripheral surface.
[18]

The heater element assembly according to any one of [1] to [17], wherein at least a part of the partition walls of the honeycomb structure portion and at least a part of the first electrode layer and the second electrode layer are coated with an adsorbent capable of adsorbing one or more selected from water, carbon dioxide, and organic gas components.

According to the heater element assembly according to one embodiment of the present invention, a resin frame body protects a heater element including a honeycomb structure portion having PTC characteristics from the outer peripheral surface side via a cushioning material. As a result, the following effects can be obtained, for example.
(1) Since the frame body is made of resin, which is softer than metal, and the cushioning material is present therebetween, the heater element is less likely to be damaged.
(2) Due to the presence of the cushioning material, the heater element is easily thermally deformed and thermal stress is reduced.
(3) Resin generally has lower thermal conductivity than metal, so making the frame body made of resin reduces heat loss.
(4) Since the frame body protects the heater element from the outer peripheral surface side, there is no need to block the openings of the cells with the frame body to protect the heater element. Even when the frame body supplementarily protects the end surface sides of the heater element, the area that blocks the openings of the cells can be minimized. Therefore, the performance (heating performance, purification performance, and the like) of the heater element can be fully demonstrated.

### BRIEF DESCRIPTION OF THE DRAWINGS

FIG. 1A is a schematic diagram of a heater element according to an embodiment of the present invention, viewed from a first end surface side.

FIG. 1B is a schematic cross-sectional view taken along line X-X in FIG. 1A.

FIG. 1C is a schematic diagram of a heater element according to another embodiment of the present invention, viewed from the first end surface side.

FIG. 1D is a schematic cross-sectional view taken along line X-X in

FIG. 1C.

FIG. 2A is a schematic diagram of an example of a heater element assembly including a frame body that holds a heater element from the outer peripheral side of the outer peripheral wall, when viewed from the first end surface side.

FIG. 2B is a schematic cross-sectional view taken along the line X-X in FIG. 2A.

FIG. 2C is a diagram schematically showing how a pair of half-split members approach from a direction perpendicular to the direction in which the flow paths of a honeycomb structure portion extend, with a heater element interposed therebetween.

FIG. 3A is a schematic diagram of another example of a heater element assembly including a frame body that holds a heater element from the outer peripheral surface side of the outer peripheral wall, when viewed from the first end surface side.

FIG. 3B is a schematic cross-sectional view taken along line X-X in FIG. 3A.

FIG. 4A is a schematic diagram of yet another example of a heater element assembly including a frame body that holds a heater element from the outer peripheral surface side of the outer peripheral wall, when viewed from the first end surface side.

FIG. 4B is a schematic cross-sectional view taken along line X-X in FIG. 4A.

FIG. 4C is a diagram schematically showing how a first tubular divisional portion and a second tubular divisional portion approach from a direction parallel to the direction in which the flow paths of a honeycomb structure portion extend, with the heater element interposed therebetween.

FIG. 5 is a schematic diagram showing a configuration example of an air conditioning system according to an embodiment of the present invention.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### (1. Heater Element)

The heater element according to one embodiment of the present invention can be suitably used to improve the interior environment in various vehicles such as automobiles. Vehicles include, but are not limited to, automobiles and trains. Examples of automobiles include, but are not particularly limited to, gasoline cars, diesel cars, gas fuel cars using CNG (compressed natural gas), LNG (liquefied natural gas) or the like, fuel cell cars, electric cars, and plug-in hybrid cars. The heater element according to one embodiment of the present invention can be particularly suitably used in vehicles without an internal combustion engine, such as electric cars and trains.

Furthermore, the heater element according to one embodiment of the present invention can be used not only for vehicles but also for improving interiors spaces of buildings such as houses, offices, factories, stores, warehouses, and freezers, and of vehicles such as ships and airplanes.

The heater element according to one embodiment of the present invention can not only be used for heating purposes, but also can have a function of removing components to be removed from the air, and can contribute to improving the interior environment. For example, by providing a functional material-containing layer that has the function of adsorbing components to be removed in the air such as water vapor, carbon dioxide, and odor components on the surface of the partition walls that forms the flow paths inside the cells of the heater element, such functions can be imparted.

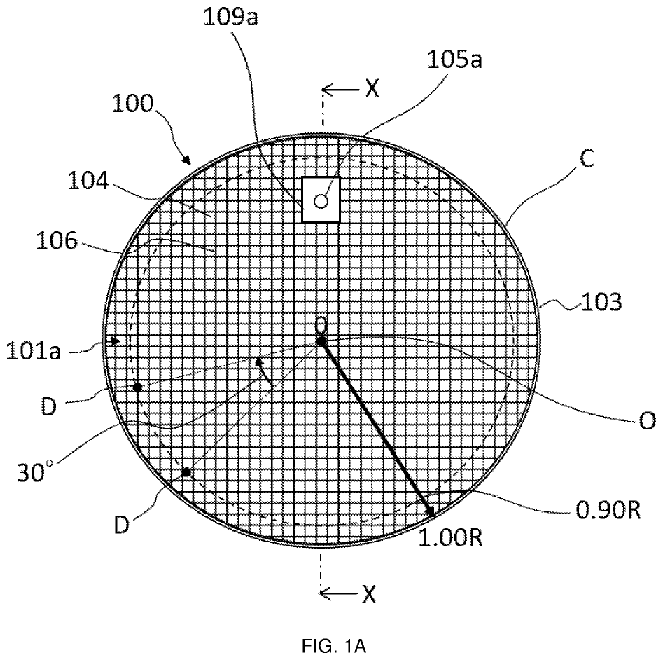

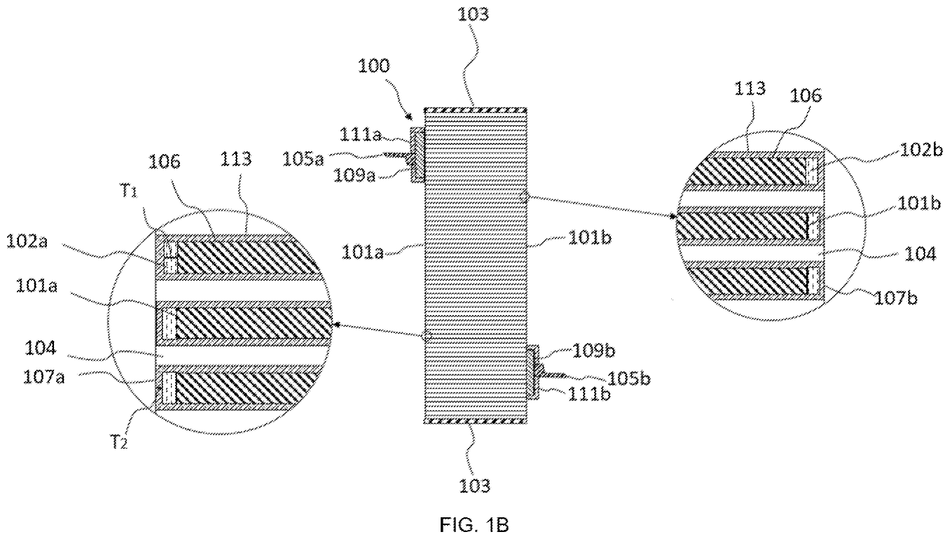

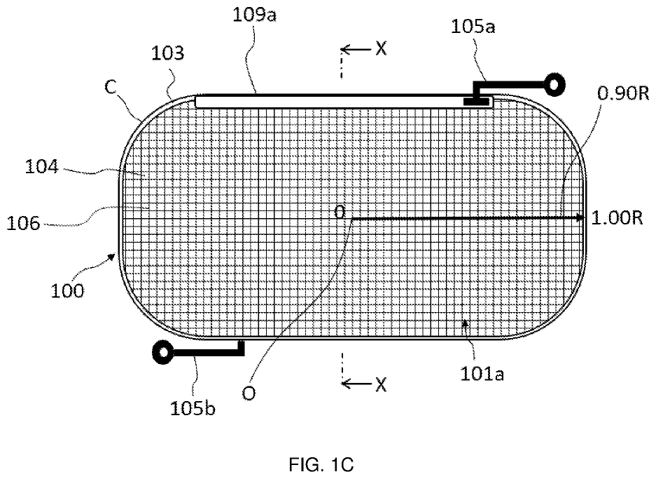

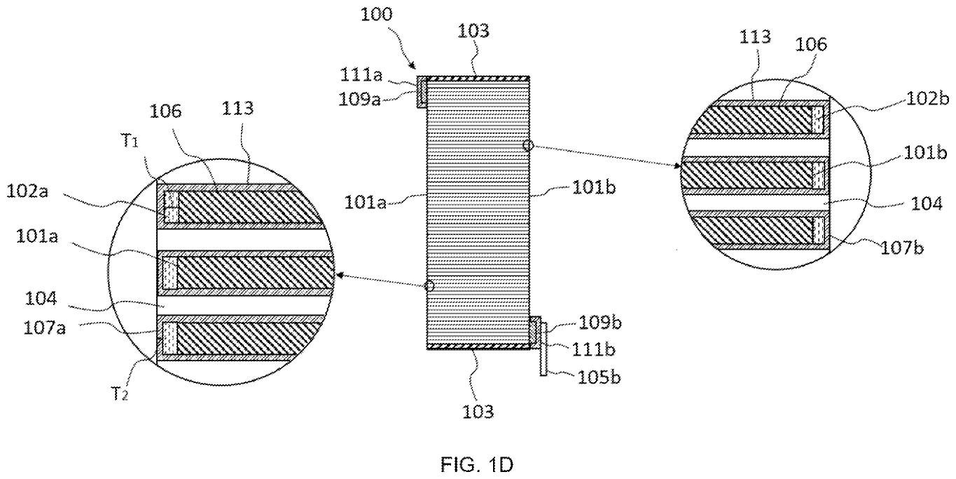

FIG. 1A shows a schematic diagram of a heater element 100 according to an embodiment of the present invention when viewed from the first end surface side. FIG. 1B shows a schematic cross-sectional view taken along the line X-X of FIG. 1A. FIG. 1C shows a schematic diagram of a heater element 100 according to another embodiment of the present invention when viewed from the first end surface side. FIG. 1D shows a schematic cross-sectional view taken along the line X-X of FIG. 1C.

The heater element 100 comprises a honeycomb structure portion, the honeycomb structure portion comprising an outer peripheral wall 103; and partition walls 106 that are disposed on the inner peripheral side of the outer peripheral wall 103 and partition a plurality of cells 104 forming flow paths extending from the first end surface 101a to the second end surface 101b.

The heater element 100 comprises a first electrode layer 102a that covers a part or all of the surface of partition walls 106 forming the first end surface 101a; and a second electrode layer 102b that covers a part or all of the surface of the partition wall 106 forming the second end surface 101b.

The heater element 100 comprises a first functional material-containing layer 107a that covers a part of the outer surface of the first electrode layer 102a (thereby indirectly covering the first end surface 101a); and a second functional material-containing layer 107b that covers a part of the outer surface of the second electrode layer 102b (thereby indirectly covering the second end surface 101b).

The heater element 100 comprises a first terminal 109a connected to the outer surface of the first electrode layer 102a (if the first functional material-containing layer 107a is provided, it is preferably a portion of the outer surface of the first electrode layer 102a that is not covered by the first functional material-containing layer 107a.); and a second terminal 109b connected to the outer surface of the second electrode layer 102b (if the second functional material-containing layer 107b is provided, it is preferably a portion of the outer surface of the second electrode layer 102b that is not covered by the second functional material-containing layer 107b.).

The heater element 100 comprises a third functional material-containing layer 111a that covers a part of the outer surface of the first terminal 109a; and a fourth functional material-containing layer 111b that covers a part of the outer surface of the second terminal 109b.

The heater element 100 comprises a fifth functional material-containing layer 113 that covers a part or all of the surface of the partition walls 106 that forms the flow paths inside the cells 104.

Hereinafter, the configuration of heater element 100 will be described in detail.

### (1-1. Honeycomb Structure Portion)

The shape of the honeycomb structure portion is not particularly limited. For example, the outer shape of the cross-section orthogonal to the direction in which the flow paths of the honeycomb structure portion extend (the direction in which the cells 104 extend) can be polygons (quadrangles (rectangles, squares), pentagons, hexagons, heptagons, octagons, and the like), round shapes (circle shapes, ellipse shapes, oval shapes, ovate shapes, oblong shapes, rounded quadrangles (a quadrangle whose sides and corners are curved, and the radius of curvature of each side is larger than the radius of curvature of each corner, and whose entire shape is composed of curves) and the like) and the like. Further, when the outer shape of the cross-section is a polygon, the corners may be chamfered. In order to prevent damage to the honeycomb structure portion and to make it easier to wrap the cushioning material around the outer peripheral surface, it is particularly preferable that the corners have an R-chamfered shape, and it is more preferable that the corners do not have a radius of curvature of 5 mm or less, and it is even more preferable that the radius of curvature of the corners is 10 mm or more, even more preferably 20 mm or more. Although the upper limit of the radius of curvature of the corners is not limited, it can be 40 mm or less, and is typically 30 mm or less. If the radius of curvature of the corners of the heater element 100 is small, the cushioning material at the corners may be omitted. However, the frame body should have a baffle that covers the portion where the cushioning material is omitted so that a bypass flow of gas does not occur in the part where the cushioning material is omitted.

In addition, the end surfaces (first end surface 101a and second end surface 101b) have the same shape as the cross-section. In the heater element 100 shown in FIGS. 1A and 1B, the cross-section of the honeycomb structure portion has a circular outer shape, and the honeycomb structure portion has a cylindrical outer shape as a whole. In the heater element 100 shown in FIGS. 1C and 1D, the outer shape of the cross-section of the honeycomb structure portion is a rectangle with an R chamfer, and the outer shape of the honeycomb structure portion as a whole is a quadrangular prism shape with an R chamfer.

The opening shape of the cells 104 is not particularly limited and in the cross-section orthogonal to the direction in which the flow paths of the honeycomb structure portion extend, it can be polygons (quadrangles (rectangles, squares), pentagons, hexagons, heptagons, octagons, and the like), round shapes (circle shapes, ellipse shapes, oval shapes, ovate shapes, oblong shapes and the like) and the like. These shapes may be single or a combination of two or more shapes. Further, among these shapes, a quadrangle or a hexagon is preferable. By providing cells 104 having such a shape, pressure loss when air flows can be reduced. When the opening shape of the cells 104 is polygonal, the corners may be rounded. In addition, in the illustrated heater element 100, the opening shape of the cells 104 is square.

The honeycomb structure portion may be a honeycomb joined body having a plurality of honeycomb segments and joining layers that joins the outer peripheral surfaces of the plurality of honeycomb segments. By using a honeycomb joined body, it is possible to increase the total cross-sectional area of the cells 104, which is important for ensuring the flow rate of air, while suppressing the occurrence of cracks. The joining layers can be formed using a joining material. The joining material is not particularly limited, but a paste made by adding a solvent such as water to a ceramic material can be used. The joining material may contain a material having PTC characteristics, or may contain the same material as the outer peripheral wall 103 and the partition walls 106. In addition to the role of joining honeycomb segments, the joining material can also be used as an outer peripheral coating material after joining the honeycomb segments.

From the view point of ensuring the strength of the honeycomb structure portion, reducing pressure loss when air passes through the cells 104, ensuring the amount of functional material carried, and ensuring the contact area with the air flowing inside the cells 104, electrical resistance between end surfaces, and the like, it is desirable to appropriately coordinate the thickness of the partition walls 106, cell density, and cell pitch (or opening ratio of cell).

In this specification, the thickness of a partition wall 106 refers to a crossing length of a line segment that crosses the partition wall 106 when the centers of gravity of adjacent cells 104 are connected by this line segment in a cross-section orthogonal to the direction in which the flow paths extend. In addition, the thickness of the partition walls 106 refers to an average value of all the thickness of the partition walls 106.

In this specification, the cell density refers to a value obtained by dividing the number of cells by the area of one end surface of the honeycomb structure portion (the total area of the partition walls 106 and the cells 104 excluding the outer peripheral wall 103).

In this specification, the cell pitch refers to a value determined by the following calculation. First, the area per cell is calculated by dividing the area of one end surface of the honeycomb structure portion (the total area of the partition walls 106 and the cells 104 excluding the outer peripheral wall 103) by the number of cells. Next, the square root of the area per cell is calculated, and this is taken as the cell pitch.

In this specification, the opening ratio of the cell 104 is a value obtained by dividing the total area of the cells 104 partitioned by the partition walls 106 by the area of one end surface (the total area of the partition walls 106 and the cells 104 excluding the outer peripheral wall 103), in the cross-section orthogonal to the direction in which the flow paths of the honeycomb structure portion extend. In addition, when calculating the opening ratio of the cells 104, layers provided on the partition walls 106, such as an electrode layer and a functional material-containing layer, are not taken into account.

In an embodiment that is advantageous from the viewpoint of supporting a sufficient amount of functional material, the thickness of the partition walls is 0.180 mm or less, the cell density is 100 cells/cm² or less, and the cell pitch is 1.0 mm or more. In a preferred embodiment, the thickness of the partition walls is 0.130 mm or less, the cell density is 70 cells/cm² or less, and the cell pitch is 1.2 mm or more. In a more preferred embodiment, the thickness of the partition walls is 0.100 mm or less, the cell density is 65 cells/cm² or less, and the cell pitch is 1.3 mm or more.

In each of the above embodiments, from the viewpoint of ensuring the strength of the honeycomb structure portion and keeping the electrical resistance low, the lower limit of the thickness of the partition walls is preferably 0.010 mm or more, more preferably 0.020 mm or more, and even more preferably 0.030 mm or more.

In each of the above embodiments, from the viewpoint of ensuring the strength of the honeycomb structure portion, keeping the electrical resistance low, and increasing the surface area to promote reaction, adsorption, and detachment by the functional material, the lower limit of the cell density is preferably 30 cells/cm² or more, more preferably 35 cells/cm² or more, and even more preferably 40 cells/cm² or more.

In each of the above embodiments, from the viewpoint of ensuring the strength of the honeycomb structure portion, keeping the electrical resistance low, and increasing the surface area to promote reaction, adsorption, and detachment by the functional material, the upper limit of the cell pitch is preferably 2.0 mm or less, more preferably 1.8 mm or less, and even more preferably 1.6 mm or less.

In an embodiment that is advantageous from the viewpoint of both reducing pressure loss and maintaining strength, the thickness of the partition walls is 0.08 mm or more and 0.36 mm or less, and the cell density is 2.54 cells/cm² or more and 140 cells/cm² or less, and the opening ratio of the cells is 0.70 or more. In a preferred embodiment, the thickness of the partition walls is 0.09 mm or more and 0.35 mm or less, the cell density is 15 cells/cm² or more and 100 cells/cm² or less, and the opening ratio of the cells is 0.75 or more. In a more preferred embodiment, the thickness of the partition walls is 0.10 mm or more and 0.30 mm or less, the cell density is 20 cells/cm² or more and 90 cells/cm² or less, and the cell opening ratio is 0.77 or more.

In each of the above embodiments, from the viewpoint of ensuring the strength of the honeycomb structure portion, the upper limit of the opening ratio of the cells is preferably 0.94 or less, more preferably 0.92 or less, and even more preferably 0.90 or less.

The thickness of the outer peripheral walls 103 is not particularly limited, but is preferably determined based on the following viewpoint. First, from the viewpoint of reinforcing the honeycomb structure portion, the thickness of the outer peripheral wall 103 is preferably 0.05 mm or more, more preferably 0.06 mm or more, and even more preferably 0.08 mm or more. On the other hand, from the viewpoint of suppressing the initial current by increasing electrical resistance, and from the viewpoint of reducing pressure loss when air flows, the thickness of the outer peripheral wall 103 is preferably 1.0 mm or less, more preferably 0.5 mm or less, even more preferably 0.4 mm or less, and even more preferably 0.3 mm or less.

In this specification, the thickness of the outer peripheral wall 103 refers to a length in the normal direction of the outer peripheral surface from the boundary between the outer peripheral wall 103 and the outermost cell 104 or partition wall 106 to the outer peripheral surface of the honeycomb structure portion, in a cross-section orthogonal to the direction in which the flow paths extend.

The length of the honeycomb structure portion in the direction in which the flow paths extend, and the cross-sectional area orthogonal to the direction in which the flow paths extend may be adjusted according to the required size of the heater element, and are not particularly limited. For example, when used in a compact heater element while ensuring a predetermined function, the length of the honeycomb structure portion in the direction in which the flow paths extend may be 2 to 50 mm, typically 5 to 50 mm, and the cross-sectional area orthogonal to the direction in which the flow paths extend can be 30 to 400 cm², typically 50 to 150 cm².

The partition walls 106 forming the honeycomb structure portion are made of a material that can generate heat when energized. Specifically, they are made of a material having PTC (Positive Temperature Coefficient) characteristics. If necessary, the outer peripheral wall 103 may also be made of a material having PTC characteristics like the partition walls 106.

When a functional material-containing layer is provided on the partition walls 106, it is possible to heat the functional material-containing layer by heat transfer from the heat-generated partition walls 106 (and the outer peripheral wall 103 as necessary). Furthermore, a material having PTC characteristics has a characteristic that when the temperature rises and exceeds the Curie point, the resistance value rapidly increases and it becomes difficult for electricity to flow. Therefore, when the heater element 100 reaches a high temperature, the current flowing through the partition walls 106 (and the outer peripheral wall 103 as necessary) is restricted, so that excessive heat generation of the heater element 100 is suppressed. Therefore, it is also possible to suppress thermal deterioration of the functional material-containing layer caused by excessive heat generation.

From the viewpoint of obtaining appropriate heat generation, the lower limit of the volume resistivity at 25° C. of the material having PTC characteristics is preferably 0.5 Ω·cm or more, more preferably 1 Ω·cm or more, even more preferably 5 Ω·cm or more, and even more preferably 10 Ω·cm or more. From the viewpoint of generating heat with a low driving voltage, the upper limit of the volume resistivity at 25° C. of the material having PTC characteristics is preferably 30 Ω·cm or less, preferably 20 Ω·cm or less, more preferably 18 Ω·cm or less, and even more preferably 16 Q·cm or less. Therefore, the range of volume resistivity at 25° C. of a material having PTC characteristics can be, for example, 10 Ω·cm to 30 Ω·cm. In this specification, the volume resistivity at 25° C. of a material having PTC characteristics is measured according to JIS K6271: 2008.

From the viewpoint of being able to conduct electricity and generating heat, as well as having PTC characteristics, the outer peripheral wall 103 and the partition walls 106 are preferably made of a material containing barium titanate (BaTiO₃) as a main component, and more preferably a ceramic made of a material whose main component is barium titanate (BaTiO₃)-based crystal grains in which a part of Ba is replaced with a rare earth element. In addition, in this specification, the term “main component” refers to a component that accounts for more than 50% by mass of the entire components. The content of BaTiO₃-based crystal grains can be determined by fluorescent X-ray analysis. Other crystal grains can also be measured in the same manner as this method.

The compositional formula of BaTiO₃-based crystal grains in which a part of Ba is replaced with a rare earth element can be expressed as (Ba₁₋ₓAₓ)TiO₃. In the composition formula, A represents one or more rare earth elements, and 0.0001≤x≤0.010.

A is not particularly limited as long as it is a rare earth element, but is preferably one or more selected from the group consisting of La, Ce, Pr, Nd, Eu, Gd, Dy, Ho, Er, Y, and Yb, and is more preferably is La. From the viewpoint of suppressing electrical resistance from becoming too high at room temperature, x is preferably 0.001 or more, more preferably 0.0015 or more. On the other hand, from the viewpoint of preventing the electrical resistance from becoming too high at room temperature due to insufficient sintering, x is preferably 0.009 or less.

The content of BaTiO₃-based crystal grains in which a part of Ba is replaced with a rare earth element in the ceramic is not particularly limited as long as it becomes the main component, but preferably it is 90% by mass or more, more preferably 92% by mass or more, and even more preferably 94% by mass or more. In addition, the upper limit of the content of BaTiO₃-based crystal grains is not particularly limited, but is generally 99% by mass or less, preferably 98% by mass or less.

From the viewpoint of reducing environmental load, it is desirable that the materials used for the outer peripheral wall 103 and the partition walls 106 substantially do not contain lead (Pb). Specifically, the outer peripheral wall 103 and the partition walls 106 have a Pb content of preferably 0.01% by mass or less, more preferably 0.001% by mass or less, and even more preferably 0% by mass. Due to the low Pb content, for example, air heated by contact with the partition walls 106 that is generating heat can be safely applied to living things such as humans. In addition, in the outer peripheral wall 103 and the partition walls 106, the Pb content is preferably less than 0.03 mass %, more preferably less than 0.01 mass %, and even more preferably 0 mass % when calculated in terms of PbO. The content of lead can be determined by ICP-MS (inductively coupled plasma mass spectrometry).

The lower limit of the Curie point of the material constituting the outer peripheral wall 103 and the partition walls 106 is preferably 100° C. or higher, more preferably 110° C. or higher, and even more preferably 125° C. or higher, from the viewpoint of efficiently heating air. Further, regarding the upper limit of the Curie point, from the viewpoint of safety for parts placed in the interior, especially in or near a vehicle interior, it is preferably 250° C. or lower, more preferably 225° C. or lower, even more preferably 200° C. or lower, even more preferably 150° C. or lower, and even more preferably 130° C. or lower. Therefore, the range of the Curie point of the material constituting the outer peripheral wall 103 and the partition walls 106 can be, for example, 100° C. or more and 130° C. or less.

The Curie point of the material constituting the outer peripheral wall 103 and the partition walls 106 can be adjusted by the type and amount of shifter added. For example, the Curie point of barium titanate (BaTiO₃) is approximately 120° C., but by replacing a portion of Ba and Ti with one or more of Sr, Sn, and Zr, the Curie point can be shifted to the lower temperature side.

In this specification, the Curie point is measured by the following method. A sample is attached to a sample holder for measurement, and placed in a measurement tank (for example, MINI-SUBZERO MC-810P manufactured by ESPEC Corp.). The change in electrical resistance of the sample with respect to temperature change when the temperature is increased from 10° C. is measured using a DC resistance meter (for example, multimeter 3478A manufactured by YOKOGAWA HEWLETT PACKARD, LTD.). According to the electrical resistance-temperature plot obtained by measurement, the temperature at which the resistance value becomes twice the resistance value at room temperature (20° C.) is defined as the Curie point.

### (1-2. Electrode Layer)

The first electrode layer 102a is provided on the first end surface 101a, and the second electrode layer 102b is provided on the second end surface 101b. By applying a voltage between the first electrode layer 102a and the second electrode layer 102b, it is possible to cause the honeycomb structure portion to generate heat using Joule heat.

Specifically, the first electrode layer 102a covers a part or all of the surface of the partition walls 106 forming the first end surface 101a. The second electrode layer 102b covers a part or all of the surface of the partition walls 106 forming the second end surface 101b. In order to easily spread the current over the entire first end surface 101a, it is preferable that the first electrode layer 102a covers 80% or more, more preferably 90% or more, and even more preferably 99% or more of the area of the first end surface 101a excluding the openings of the cells 104 (that is, partition wall portions and outer peripheral wall portion). Similarly, in order to easily spread the current over the entire second end surface 101b, it is preferable that the second electrode layer 102b covers 80% or more, more preferably 90% or more, and even more preferably 99% or more of the area of the second end surface 101b excluding the openings of the cells 104 (that is, partition wall portions and outer peripheral wall portion).

The first electrode layer 102a and the second electrode layer 102b are not particularly limited, but for example, a metal or alloy containing at least one selected from Cu, Ag, Al, Ni, and Si can be used. In a preferred embodiment, the first electrode layer 102a and the second electrode layer 102b contain pure aluminum and/or an aluminum alloy. Further, it is also possible to use an ohmic electrode that can make ohmic contact with the outer peripheral wall 103 and/or the partition walls 106 having PTC characteristics. The ohmic electrode contains, for example, at least one selected from Al, Au, Ag, and In as a base metal, and an ohmic electrode containing at least one selected from Ni, Si, Zn, Ge, Sn, Se, and Te for n-type semiconductors as a dopant can be used. Further, the first electrode layer 102a and the second electrode layer 102b may have a single layer structure or may have a laminated structure of two or more layers. When the first electrode layer 102a and the second electrode layer 102b have a laminated structure of two or more layers, the material of each layer may be the same or different. In preferred embodiments, the first electrode layer 102a and the second electrode layer 102b may have a single layer of pure aluminum, a double layer structure of Al—Ni alloy layer and pure silver layer, or a double layer structure of Al—Ni alloy layer and pure aluminum layer.

The thicknesses of the first electrode layer 102a and the second electrode layer 102b are not particularly limited, and can be appropriately set depending on the method of forming the first electrode layer 102a and the second electrode layer 102b. Examples of methods for forming the first electrode layer 102a and the second electrode layer 102b include metal deposition methods such as sputtering, vapor deposition, electrolytic deposition, and chemical deposition. Further, the electrode layer can also be formed by applying an electrode paste and then baking it, or by thermal spraying. Further, the electrode layer may be formed by joining a metal plate or an alloy plate such as a punched metal plate having through holes at locations corresponding to the openings of the cells.

The average thicknesses of the first electrode layer 102a and the second electrode layer 102b is not limited, and it can be, for example, 5 μm or more and 100 μm or less. By setting the lower limit of the average thickness of the first electrode layer 102a and the second electrode layer 102b to 5 μm or more, preferably 10 μm or more, and more preferably 20 μm or more, there is an advantage that abnormal heat generation in the electrode layers can be avoided. By setting the upper limit of the average thickness of the first electrode layer 102a and the second electrode layer 102b to 100 μm or less, preferably 80 μm or less, and more preferably 60 μm or less, there is an advantage that the rigidity of the electrode layers can be suppressed and they are difficult to peel off from the end surface of the honeycomb structure portion.

The average thickness of the first electrode layer 102a is measured by the following procedure. First, a cross-sectional image of the first electrode layer is obtained at a magnification of approximately 50 times using a scanning electron microscope or the like. The cross-section is parallel to the direction in which the flow paths of the honeycomb structure portion extend. In the cross-sectional image, as illustrated in the partially enlarged view of FIG. 1B, since the first electrode layer is visible for each partition wall, for each of the first electrode layers, a thickness T₁ at the central position of the length of the partition wall forming the first end surface covered by the first electrode layer in the direction perpendicular to the direction in which the flow paths extend is measured at two locations per cross-sectional image. The direction of the thickness is parallel to the direction in which the flow paths extend. In this way, a large number of cross-sectional images of the first electrode layer are uniformly acquired from the vicinity of the first end surface of the heater element, and the thickness T₁ of the first electrode layer is measured at ten or more locations in total. The average value of all the measured thicknesses T₁ is taken as the average thickness of the first electrode layer. The average thickness of the second electrode layer 102b is also measured using the same procedure.

Preferably, the terminals are arranged on the outer peripheral portion. Therefore, when the thickness of the electrode layer at the connection location of the outer peripheral portion with the terminal is large, the material of the electrode layer melts during joining, making it possible to secure a sufficient joining area with the terminal, and increasing the joining strength with the terminal. Furthermore, since a sufficient joining area with the terminal can be ensured, it is possible to improve the conduction performance between the electrode layer and the terminal. Therefore, the heater element 100 preferably satisfies at least one of the following conditions (1) and (2), and more preferably satisfies both conditions.
(1) The average value of the thickness of the first electrode layer 102a at the connection location of the outer peripheral portion of the first end surface 101a with the first terminal 109a is larger than the average value of the thickness of the first electrode layer 102a at other portions.
(2) The average value of the thickness of the second electrode layer 102b at the connection location of the outer peripheral portion of the second end surface 101b with the second terminal 109b is larger than the average value of the thickness of the second electrode layer 102b at other portions.

The average value of the thickness of the first electrode layer 102a (second electrode layer 102b) at the connection location of the outer peripheral portion of the first end surface 101a (second end surface 101b) with the first terminal 109a (second terminal 109b) is preferably 1.1 to 2.0 times, more preferably 1.5 to 1.6 times with respect to the average value of the thickness of the first electrode layer 102a (second electrode layer 102b) at other portions.

The average value of the thickness of the first electrode layer 102a (second electrode layer 102b) at the connection location of the outer peripheral portion of the first end surface 101a (second end surface 101b) with the first terminal 109a (second terminal 109b) is not limited, and can be, for example, 5.5 μm or more and 200 μm or less. When the lower limit of the average value is 5.5 μm or more, preferably 11 μm or more, and more preferably 22 μm or more, an advantage is obtained that good conduction performance can be ensured. By setting the upper limit of the average value to 200 μm or less, preferably 160 μm or less, and more preferably 120 μm or less, an advantage is obtained that the pressure loss during air blowing can be reduced due to the ensured openings of the cells 104.

The average thickness of the first electrode layer 102a at the connection location of the outer peripheral portion of the first end surface 101a with the first terminal 109a is measured by the following procedure. First, a cross-sectional image of the first electrode layer at a magnification of about 50 times is obtained at the connection location of the outer peripheral portion of the first end surface 101a with the first terminal 109a using a scanning electron microscope or the like. The cross-section is parallel to the direction in which the flow paths of the honeycomb structure portion extend. In the cross-sectional image, as illustrated in the partially enlarged view of FIG. 1B, since the first electrode layer is visible for each partition wall, for each of the first electrode layers at the connection location of the outer peripheral portion of the first end surface with the first terminal, a thickness T₁ at the central position of the length of the partition wall forming the first end surface covered by the first electrode layer in the direction perpendicular to the direction in which the flow paths extend is measured at two locations per cross-sectional image. The direction of the thickness is parallel to the direction in which the flow paths extend. In this way, a large number of cross-sectional images of the first electrode layer at the connection location of the outer peripheral portion of the first end surface with the first terminal are uniformly acquired from the vicinity of the first end surface of the heater element, and the thickness T₁ of the first electrode layer is measured at ten or more locations in total. The average value of all the measured thicknesses T₁ is taken as the average thickness of the first electrode layer 102a at the connection location of the outer peripheral portion of the first end surface 101a with the first terminal 109a. The average thickness of the second electrode layer 102b at the connection location of the outer peripheral portion of the second end surface 101b with the second terminal 109b is also measured using the same procedure. In addition, the definition of the outer peripheral portion will be described later.

The average thickness of the first electrode layer 102a at the portions other than the connection location of the outer peripheral portion of the first end surface 101a with the first terminal 109a is measured by the following procedure. First, a cross-sectional image of the first electrode layer at a magnification of about 50 times is obtained at a portion other than the connection location of the outer peripheral portion of the first end surface 101a with the first terminal 109a using a scanning electron microscope or the like. The cross-section is parallel to the direction in which the flow paths of the honeycomb structure portion extend. In the cross-sectional image, as illustrated in the partially enlarged view of FIG. 1B, since the first electrode layer is visible for each partition wall, for each of the first electrode layers at the portions other than the connection location of the outer peripheral portion of the first end surface with the first terminal, a thickness T₁ at the center of the length of the partition wall forming the first end surface covered by the first electrode layer in the direction perpendicular to the direction in which the flow paths extend is measured at two locations per cross-sectional image. The direction of the thickness is parallel to the direction in which the flow paths extend. In this way, a large number of cross-sectional images of the first electrode layer at the portions other than the connection location of the outer peripheral portion of the first end surface with the first terminal are uniformly acquired from the vicinity of the first end surface of the heater element, and the thickness T₁ of the first electrode layer is measured at ten or more locations in total. The average value of all the measured thicknesses T₁ is taken as the average thickness of the first electrode layer 102a at the portions other than the connection location of the outer peripheral portion of the first end surface 101a with the first terminal 109a. The average thickness of the second electrode layer 102b at the portions other than the connection location of the outer peripheral portion of the second end surface 101b with the second terminal 109b is also measured using the same procedure. In addition, the definition of the outer peripheral portion will be described later.

As mentioned above, when the thickness of the electrode layer at the connection location of the outer peripheral portion with the terminal is large, the terminal is firmly connected to the electrode layer, and it becomes possible to improve conduction performance between the electrode layer and the terminal. On the other hand, in order to increase the degree of freedom in the region to which the terminals are connected, it is preferable to increase the thickness of the electrode layer over the entire outer peripheral portion. Therefore, the heater element 100 preferably satisfies at least one of the following conditions (3) and (4), and more preferably satisfies both conditions.
(3) The average thickness of the first electrode layer 102a over the entire outer peripheral portion of the first end surface 101a is larger than the average thickness of the first electrode layer 102a at other portions.
(4) The average value of the thickness of the second electrode layer 102b over the entire outer peripheral portion of the second end surface 101b is larger than the average value of the thickness of the second electrode layer 102b at other portions.

The average thickness of the first electrode layer 102a over the entire outer peripheral portion of the first end surface 101a is measured by the following procedure. First, a cross-sectional image of the first electrode layer at a magnification of about 50 times is obtained at an arbitrary point on the outer peripheral portion of the first end surface using a scanning electron microscope or the like. The cross-section is parallel to the direction in which the flow paths of the honeycomb structure portion extend. In the cross-sectional image, as illustrated in the partially enlarged view of FIG. 1B, since the first electrode layer is visible for each partition wall, for each of the first electrode layers at the outer peripheral portion of the first end surface, a thickness T₁ at the center of the length of the partition wall forming the first end surface covered by the first electrode layer in the direction perpendicular to the direction in which the flow paths extend is measured at two locations per cross-sectional image. The direction of the thickness is parallel to the direction in which the flow paths extend. In this way, a large number of cross-sectional images of the first electrode layer on the outer peripheral portion of the first end surface are acquired at equal intervals in the peripheral direction from the vicinity of the first end surface of the heater element, and the thickness T₁ of the first electrode layer is measured at ten or more locations in total. The average value of all the measured thicknesses T₁ is taken as the average thickness of the first electrode layer 102a over the entire outer peripheral portion of the first end surface 101a. The average thickness of the second electrode layer 102b over the entire outer peripheral portion of the second end surface 101b is also measured using the same procedure. In addition, the definition of the outer peripheral portion will be described later.

The average thickness of the first electrode layer 102a at the portions other than the outer peripheral portion of the first end surface 101a is measured by the following procedure. First, a cross-sectional image of the first electrode layer at a magnification of about 50 times is obtained at a portion other than the outer peripheral portion of the first end surface using a scanning electron microscope or the like. The cross-section is parallel to the direction in which the flow paths of the honeycomb structure portion extend. In the cross-sectional image, as illustrated in the partially enlarged view of FIG. 1B, since the first electrode layer is visible for each partition wall, for each of the first electrode layers at the portions other than the outer peripheral portion of the first end surface, a thickness T₁ at the center of the length of the partition wall forming the first end surface covered by the first electrode layer in the direction perpendicular to the direction in which the flow paths extend is measured at two locations per cross-sectional image. The direction of the thickness is parallel to the direction in which the flow paths extend. In this way, a large number of cross-sectional images of the first electrode layer at the portions other than the outer peripheral portion of the first end surface are acquired uniformly from the vicinity the first end surface of the heater element, and the thickness T₁ of the first electrode layer is measured at ten or more locations in total. The average value of all the measured thicknesses T₁ is taken as the average thickness of the first electrode layer 102a at the portions other than the outer peripheral portion of the first end surface 101a. The average thickness of the second electrode layer 102b at the portions other than the outer peripheral portion of the second end surface 101b is also measured using the same procedure. In addition, the definition of the outer peripheral portion will be described later.

The lower limit of the volume resistivity at 25° C. of the first electrode layer 102a and the second electrode layer 102b is not particularly limited, but a normally achievable range is 1.0×10⁻⁷ Ω·cm or more. From the viewpoint of ensuring sufficient current spread in the plane and uniform temperature distribution, the upper limit of the volume resistivity of the first electrode layer 102a and the second electrode layer 102b at 25° C. is preferably 1.0×10⁻⁵ Ω·cm or less, preferably 1.0×10⁻⁶ Ω·cm or less, more preferably 5.0×10⁻⁷ Ω·cm or less, and even more preferably 3.0×10⁻⁷ Ω·cm or less. Therefore, the range of the volume resistivity of the first electrode layer 102a and the second electrode layer 102b at 25° C. can be, for example, 1.0×10⁻⁷ Ω·cm or more and 1.0×10⁻⁵ Ω·cm or less. In this specification, the volume resistivity at 25° C. of the first electrode layer 102a and the second electrode layer 102b is measured according to JIS K6271: 2008.

### (1-3. First and Second Functional Material-Containing Layers)

The first functional material-containing layer 107a may cover a part of the outer surface of the first electrode layer 102a, and the second functional material-containing layer 107b may cover a part of the outer surface of the second electrode layer 102b. When the functional material-containing layer is present on the end surface side of the heater element, the functionality provided by the functional material can be imparted to the heater element. For example, when the first functional material-containing layer 107a and the second functional material-containing layer 107b contain a moisture absorbent, it is possible to suppress the migration of metal components in the electrode layers and short circuit between the electrode layers. The outer surface of the first electrode layer 102a refers to the surface opposite to the surface where the first electrode layer 102a contacts the first end surface 101a. The outer surface of the second electrode layer 102b refers to the surface opposite to the surface where the second electrode layer 102b contacts the second end surface 101b.

The reason why the first functional material-containing layer 107a covers “a part” of the outer surface of the first electrode layer 102a is because the portion of the outer surface of the first electrode layer 102a to which the first terminal 109a is connected should not be covered with the first functional material-containing layer 107a, and therefore it is not entirely covered. Similarly, the reason why the second functional material-containing layer 107b covers “a part” of the outer surface of the second electrode layer 102b is because the portion of the outer surface of the second electrode layer 102b to which the second terminal 109b is connected should not be covered with the second functional material-containing layer 107b, and therefore it is not entirely covered.

In order to improve the performance of the functional material, the first functional material-containing layer 107a preferably covers 80% or more, more preferable covers 90% or more, and even more preferably covers 99% or more of the area of the portion of the outer surface of the first electrode layer 102a to which the first terminal 109a is not connected. Similarly, the second functional material-containing layer 107b preferably covers 80% or more, more preferable covers 90% or more, and even more preferably covers 99% or more of the area of the portion of the outer surface of the second electrode layer 102b to which the second terminal 109b is not connected.

The first functional material-containing layer 107a and the second functional material-containing layer 107b are preferably insulative. The vicinity of the first end surface 101a and the vicinity of the second end surface 101b are areas where foreign flying objects tend to adhere, and if the flying objects have conductivity, they may cause a short circuit. When the first functional material-containing layer 107a and the second functional material-containing layer 107b are insulative, short circuits caused by flying objects can be prevented. In this specification, the fact that the first functional material-containing layer 107a and the second functional material-containing layer 107b are insulative means that the first functional material-containing layer 107a and the second functional material-containing layer 107b each satisfy the following conditions regarding electrical resistance.

Assuming the coordinate value of the center of gravity O of the first end surface 101a (second end surface 101b) is 0, a coordinate axis is taken in the direction from the center of gravity O toward the outer peripheral contour C of the first end surface 101a (second end surface 101b), and the coordinate value on the outer peripheral contour C is assumed to be 1.00R. Then, the electrical resistance between two points on the outer surface of the first functional material-containing layer 107a (second functional material-containing layer 107b) that are the farthest apart on the line segment connecting the center of gravity O and an arbitrary point D with a coordinate value of 0.90R at 25° C. is measured by the shunt method (see FIG. 1A). The outer surface of the first functional material-containing layer 107a (second functional material-containing layer 107b) refers to the surface opposite to the surface where the first functional material-containing layer 107a (second functional material-containing layer 107b) contacts the first electrode layer 102a (second electrode layer 102b). Next, the point D is rotated by 30° degrees with the center of gravity O as the center of rotation, and the electrical resistance is measured in the same way. In this way, while rotating the point D by 30° degrees each time, the electrical resistance between the center of gravity O and the point D is measured for one round (12 locations). When the lower limit of the electrical resistance at the 12 locations obtained is 1.0×10⁴Ω or more, the first functional material-containing layer 107a (second functional material-containing layer 107b) is defined as insulative.

In addition, if the first terminal 109a (second terminal 109b) exists on the line segment connecting the point D and the center of gravity O at the location where point D has been rotated, the point D is further rotationally moved to a position where the first terminal 109a (second terminal 109b) does not exist, and then the measurement is performed.

It is preferable that the lower limit of the electrical resistance of the first functional material-containing layer 107a and the second functional material-containing layer 107b is 1.0×10⁵Ω or more, and more preferably 5.0×10⁵Ω or more. Although the upper limit of electrical resistance is not particularly set for the first functional material-containing layer 107a and the second functional material-containing layer 107b, when electrical resistance is measured using the above procedure, the range of electrical resistance is normally 1.0×10⁵Ω to 1.0×10⁷Ω, and is typically 2.0×10⁵Ω to 1.0×10⁶Ω.

It is preferable that the first functional material-containing layer 107a and the second functional material-containing layer 107b contain a moisture absorbent. In this specification, a moisture absorbent refers to a substance that has the property of adsorbing 5 g/g or more of water (g) per 1 g of its own dry mass when left for one hour in an environment at room temperature (25° C.) and 50% relative humidity. The moisture absorbent preferably has the function of adsorbing moisture at a temperature of −20 to 40° C. and releasing it at a high temperature of 60° C. or higher, preferably 70 to 180° C. In this way, when the moisture absorbent material has the function of adsorbing moisture at low temperatures and desorbing moisture at high temperatures, the moisture absorbent material can be used many times by repeating energization and de-energization.

There are no particular restrictions on the type of moisture absorbent, and mention can be made to silica gel, sepiolite, calcium oxide, diatomaceous earth, activated carbon, activated clay, zeolite, white carbon, calcium chloride, magnesium chloride, potassium acetate, dibasic sodium phosphate, sodium citrate, water-absorbing polymer, crystalline aluminum silicate, amorphous aluminum silicate, and the like. Among these, zeolite and amorphous aluminum silicate are preferable, and amorphous aluminum silicate is more preferable because they can release moisture in a relatively low temperature range. One type of moisture absorbent may be used alone, or two or more types may be used in combination. The above-mentioned moisture absorbents are merely examples, and the present invention is not limited thereto.

The first functional material containing layer 107a and the second functional material containing layer 107b may contain a binder. Although the binder includes both organic binders and inorganic binders, inorganic binders are preferred. The type of inorganic binder is not particularly limited, and mention can be made to alumina sol, silica sol, montmorillonite, boehmite, gamma alumina, and attapulgite. These may be used alone or in combination of two or more. Among these, alumina sol and silica sol are preferable, and silica sol is more preferable because adhesive strength can be easily ensured.

In addition to or instead of a moisture absorbent, the first functional material-containing layer 107a and the second functional material-containing layer 107b may contain a functional material having a function of adsorbing components to be removed in the air such as carbon dioxide and/or organic gas components. In particular, it is preferable to contain a functional material capable of adsorbing carbon dioxide and/or organic gas components at −20 to 40° C. and releasing them at a high temperature of 60° C. or higher, preferably 70 to 180° C. In this way, when the functional material has the function of adsorbing the component to be removed in the air at a low temperature and desorbing it at a high temperature, the functional material can be used many times by repeating energization and de-energization.

Organic gas components contained in the air that can be removed include, for example, volatile organic compounds (VOC) and odor components. As specific examples of harmful volatile components, mention can be made to ammonia, acetic acid, isovaleric acid, nonenal, formaldehyde, toluene, xylene, paradichlorobenzene, ethylbenzene, styrene, chlorpyrifos, di-n-butyl phthalate, tetradecane, di-2-ethylhexyl phthalate, diazinon, acetaldehyde, 2-(1-methylpropyl)phenyl N-methylcarbamate, and the like.

Some of the moisture absorbent mentioned above have these functions, and although some of the descriptions overlap, examples of such functional material include zeolite, silica gel, activated carbon, alumina, silica, low crystalline clay, and amorphous aluminum silicate complex. The type of functional material may be selected as appropriate depending on the type of component to be removed. One type of functional material may be used alone, or two or more types may be used in combination.

The first functional material-containing layer 107a and the second functional material-containing layer 107b may further contain a catalyst, for the purpose of purifying the components to be removed or increasing the ability of functional materials (including moisture absorbent) to capture the components to be removed. The catalyst preferably has a function capable of promoting redox reactions. Examples of catalysts having such functions include metal catalysts such as Pt, Pd, and Ag, and oxide catalysts such as CeO₂ and ZrO₂. One type of catalyst may be used alone, or two or more types may be used in combination.

The average thickness of at least one of the first functional material-containing layer 107a and the second functional material-containing layer 107b, preferably both, can be, for example, 10 μm or more and 500 μm or less, although this is not limited. By setting the lower limit of the average thickness of at least one, preferably both, of the first functional material-containing layer 107a and the second functional material-containing layer 107b to 10 μm or more, preferably 30 μm or more, more preferably 50 μm or more, there is an advantage of ensuring insulation and making it easier for the functional materials to perform their functions. By setting the upper limit of the average thickness of the first functional material-containing layer 107a and the second functional material-containing layer 107b to 500 μm or less, preferably 300 μm or less, and more preferably 200 μm or less, there is an advantage that the rigidity of the functional material-containing layer can be reduced, making it difficult to peel off.

The average thickness of the first functional material-containing layer 107a is measured by the following procedure. First, a cross-sectional image of the first functional material-containing layer is obtained at a magnification of approximately 50 times using a scanning electron microscope or the like. The cross-section is parallel to the direction in which the flow paths of the honeycomb structure portion extend. In the cross-sectional image, as illustrated in the partially enlarged view of FIG. 1B, since the first functional material-containing layer is visible for each partition wall, for each of the first functional material-containing layer, a thickness T₂ at the central position of the length of the partition wall forming the first end surface indirectly covered by the first functional material-containing layer in the direction perpendicular to the direction in which the flow paths extend is measured at two locations per cross-sectional image. The direction of the thickness is parallel to the direction in which the flow paths extend. Then, a large number of cross-sectional images of the first functional material-containing layer are uniformly acquired from the vicinity of the first end surface of the heater element, and the thickness T₂ of the first functional material-containing layer is measured at ten or more locations. The average value of all the measured thicknesses T₂ is taken as the average thickness of the first functional material-containing layer. The average thickness of the second functional material-containing layer 107b is also measured using the same procedure.

The first functional material-containing layer 107a preferably covers not only the outer surface of the first electrode layer 102a but also a part or all of the other exposed surface (for example, a surface parallel to the thickness direction of the first electrode layer 102a) of the first electrode layer 102a, and more preferably covers the entire exposed surface. Similarly, the second functional material-containing layer 107b preferably covers not only the outer surface of the second electrode layer 102b but also a part or all of the other exposed surface (for example, a surface parallel to the thickness direction of the second electrode layer 102b) of the second electrode layer 102b, and more preferably covers the entire exposed surface.

### (1-4. Terminal)

The first terminal 109a is connected to the outer surface of the first electrode layer 102a (if the first functional material-containing layer 107a is provided, it is preferably a portion of the outer surface of the first electrode layer 102a that is not covered by the first functional material-containing layer 107a). The second terminal 109b is connected to the outer surface of the second electrode layer 102b (if the second functional material-containing layer 107b is provided, it is preferably a portion of the outer surface of the second electrode layer 102b that is not covered by the second functional material-containing layer 107b). It is preferable that at least a part of the first terminal 109a (second terminal 109b) is disposed on the outer peripheral portion of the first end surface 101a (second end surface 101b), and it is more preferable that the first terminal 109a (second terminal 109b) is entirely disposed on the outer peripheral portion.

The connection method between the first electrode layer 102a and the first terminal 109a and between the second electrode layer 102b and the second terminal 109b is not particularly limited as long as they are electrically conductive. For example, the connection can be made by welding, brazing, mechanical contact, or the like. The material of the first terminal 109a and the second terminal 109b is not particularly limited, but may be made of metal, for example. As the metal, single metals and alloys can be used, but from the viewpoint of selecting a material that is resistant to oxidation in a humid environment, resistant to migration or electrolytic corrosion even under humid conditions, and easy to bond with electrodes, it is preferable to contain one or more selected from pure aluminum, aluminum alloy and stainless steel, and for example, it can be made of pure aluminum, aluminum alloy, or stainless steel. In addition, alloys containing at least one selected from the group consisting of Cr, Fe, Co, Ni, Cu, and Ti can also be used, and among them, Fe—Ni alloys and phosphor bronze can be preferably used. It is preferable that the terminal be made of a material similar to the electrode layer on the end surface from the viewpoint of avoiding electrolytic corrosion. In one example, both the electrode layer and the terminal are preferably made of pure aluminum and/or an aluminum alloy.

Although the shape of the first terminal 109a and the second terminal 109b is not limited, it can be, for example, flat. In that case, the plate thickness of the terminal is not limited, but it can be, for example, 0.1 to 4 mm, preferably 0.3 to 2 mm.

The area of the portion of the first end surface 101a covered (indirectly) by the first terminal 109a due to the first terminal 109a being connected to the first electrode layer 102a is not particularly limited, but if the first terminal 109a is too small, it will be difficult to connect a current-carrying component to the first terminal 109a. Conversely, if the first terminal 109a is too large, the area that closes the openings of the cells 104 becomes large, and the flow rate of air that can flow into the heater element 100 decreases. Therefore, the lower limit of the ratio of the area that the first terminal 109a covers the first end surface 101a to the area of the first end surface 101a is preferably 0.5% or more, more preferably 1% or more, and even more preferably 2% or more. Further, the upper limit of the ratio of the area that the first terminal 109a covers the first end surface 101a to the area of the first end surface 101a is preferably 10% or less, more preferably 8% or less, and even more preferably 5% or less. Therefore, the ratio of the area that the first terminal 109a covers the first end surface 101a to the area of the first end surface 101a can be, for example, 0.5% or more and 10% or less. The same applies to the ratio of the area that the second terminal 109b covers the second end surface 101b to the area of the second end surface 101b.

The lower limit of the volume resistivity at 25° C. of the first terminal 109a and the second terminal 109b is not particularly limited, but a normally achievable range is 1.0×10⁻⁷ Ω·cm or more. From the viewpoint of reducing heat generation and energy loss at the terminals, the upper limit of the volume resistivity of the first terminal 109a and the second terminal 109b at 25° C. is preferably 1.0×10⁻⁶ Ω·cm or less, preferably 5.0×10⁻⁷ Ω·cm or less, more preferably 3.0×10⁻⁷ Ω·cm or less, and even more preferably 2.0×10⁻⁷ Ω·cm or less. Therefore, the range of the volume resistivity of the first terminal 109a and the second terminal 109b at 25° C. can be, for example, from 1.0×10⁻⁷ Ω·cm to 1.0×10⁻⁶ Ω·cm. In this specification, the volume resistivity at 25° C. of the first terminal 109a and the second terminal 109b is measured according to JIS K6271: 2008.

### (1-5. Third and Fourth Functional Material-Containing Layers)

The third functional material-containing layer 111a may cover a portion of the outer surface of the first terminal 109a, and the fourth functional material-containing layer 111b may cover a portion of the outer surface of the second terminal 109b. When a functional material-containing layer is present on the outer surface of the terminal, the functionality provided by the functional material can be imparted to the heater element. For example, when the third functional material-containing layer 111a and the fourth functional material-containing layer 111b contain a moisture absorbent, it is possible to suppress migration of metal components in the terminals and short circuits. The outer surface of the first terminal 109a refers to the surface opposite to the surface where the first terminal 109a contacts the first electrode layer 102a. The outer surface of the second terminal 109b refers to the surface opposite to the surface where the second terminal 109b contacts the second electrode layer 102b.

The reason why the third functional material-containing layer 111a covers “a part” of the outer surface of the first terminal 109a is because the portion of the outer surface of the first terminal 109a to which the current-carrying component 105a is connected should not be covered with the third functional material-containing layer 111a, and therefore it is not entirely covered. Similarly, the reason why the fourth functional material-containing layer 111b covers “part” of the outer surface of the second terminal 109b is because the portion of the outer surface of the second terminal 109b to which the current-carrying component 105b is connected should not be covered with the fourth functional material-containing layer 111b, and therefore it is not entirely covered.

In order to improve the performance of the functional material, the third functional material-containing layer 111a preferably covers 80% or more, more preferable covers 90% or more, and even more preferably covers 99% or more of the area of the portion of the outer surface of the first terminal 109a to which the current-carrying component 105a is not connected. Similarly, the fourth functional material-containing layer 111b preferably covers 80% or more, more preferably covers 90% or more, and even more preferably covers 99% or more of the area of the portion of the outer surface of the second terminal 109b where the current-carrying component 105b is not connected.

The third functional material containing layer 111a and the fourth functional material containing layer 111b are preferably insulative, for the same reason as the first functional material containing layer 107a and the second functional material containing layer 107b. The fact that the third functional material-containing layer 111a and the fourth functional material-containing layer 111b are insulative means that the third functional material-containing layer 111a and the fourth functional material-containing layer 111b each satisfy the following conditions regarding electrical resistance.

The electrical resistance at 25° C. between any two points separated by 3 mm on the outer surface of the third functional material-containing layer 111a (fourth functional material-containing layer 111b) is measured by the shunt method. However, the distance between the two points is selected such that the current-carrying component 105a does not exist on the line segment connecting the two points. If the lower limit of the electrical resistance obtained is 1.0×10⁴Ω or more when measuring at three different measurement points, it is defined that the third functional material-containing layer 111a (fourth functional material-containing layer 111b) is insulative.

It is preferable that the lower limit of the electrical resistance of the third functional material-containing layer 111a and the fourth functional material-containing layer 111b is 1.0×10⁵Ω or more, and more preferably 5.0×10⁵Ω or more. Although the upper limit of electrical resistance is not particularly set for the third functional material-containing layer 111a and the fourth functional material-containing layer 111b, when electrical resistance is measured using the above procedure, the range of electrical resistance is usually 5.0×10⁵Ω to 1.0×10⁷Ω, and is typically 1.0×10⁶Ω to 5.0×10⁶Ω.

The functional materials contained in the third functional material-containing layer 111a and the fourth functional material-containing layer 111b are as described in the description regarding the first functional material-containing layer 107a and the second functional material-containing layer 107b, including the preferred embodiments.

The third functional material containing layer 111a and the fourth functional material-containing layer 111b may contain a binder. The binder is as described in the description regarding the first functional material-containing layer 107a and the second functional material-containing layer 107b, including the preferred embodiments.

The third functional material-containing layer 111a and the fourth functional material-containing layer 111b may further contain a catalyst, for the purpose of purifying components to be removed or enhancing the ability of functional materials (including moisture absorbent) to capture components to be removed. The catalyst is as described in the description regarding the first functional material-containing layer 107a and the second functional material-containing layer 107b, including the preferred embodiments.

Although the average thickness of the third functional material-containing layer 111a and the fourth functional material-containing layer 111b is not limited, it can be, for example, 10 μm or more and 500 μm or less. By setting the lower limit of the average thickness of the third functional material-containing layer 111a and the fourth functional material-containing layer 111b to be 10 μm or more, preferably 20 μm or more, and more preferably 30 μm or more, there is an advantage that it is possible to ensure insulation and that the function of the functional material is easily exhibited. By setting the upper limit of the average thickness of the third functional material-containing layer 111a and the fourth functional material-containing layer 111b to 500 μm or less, preferably 300 μm or less, and more preferably 200 μm or less, there is an advantage that the rigidity of the functional material-containing layer can be reduced, making it difficult to peel off.

The average thickness of the third functional material-containing layer 111a is determined using a section method based on JIS K5600-1-7:2014, and the average value when the thickness of the third functional material-containing layer is measured at five or more arbitrary locations is defined as the average thickness of the third functional material-containing layer. The average thickness of the fourth functional material-containing layer 111b is also measured using the same procedure.

The third functional material-containing layer 111a preferably covers not only the outer surface of the first terminal 109a but also a part or all of the other exposed surface (for example, a surface parallel to the plate thickness direction when the first terminal 109a is a flat plate) of the first terminal 109a, and more preferably covers the entire exposed surface. Similarly, the fourth functional material-containing layer 111b preferably covers not only the outer surface of the second terminal 109b but also a part or all of the other exposed surface (for example, a surface parallel to the plate thickness direction when the second terminal 109b is a flat plate) of the second terminal 109b, and more preferably covers the entire surface.

### (1-6. Fifth Functional Material-Containing Layer)

It is preferable to have a fifth functional material-containing layer 113 that covers a part or all of the surface of the partition wall 106 that forms the flow path inside the cell 104. Since air containing the components to be removed passes through the flow paths inside the cells 104, by coating the surface of the partition walls 106 that forms the flow paths with a functional material, it becomes possible to improve the performance of the heater element 100 as a whole with the functional material.

In order to improve the performance of the functional material, the fifth functional material-containing layer 113 preferably covers 80% or more, preferably covers 90% or more, and even more preferably covers 99% or more of the surface area of the partition walls 106 that form the flow paths inside the cells 104. The ratio of the area covered by the fifth functional material-containing layer 113 to the area of the surface of the partition walls 106 forming the flow paths inside the cells 104 is measured by the following procedure.
(1) From the heater element 100, cut out a cross-section that passes through the center of gravity O of the first end surface 101a (second end surface 101b) and is parallel to the direction in which the cells 104 extend.
(2) Image the obtained cross-section, and for each cell 104, by image analysis, determine the ratio of the length of the portion covered by the fifth functional material-containing layer 113 to the length of the surface of the partition wall 106 that forms the flow path inside the cell 104 in the direction in which the cell extends. The average value of the ratio measured for all cells 104 in the cross-section is regarded as the ratio of the area covered by the fifth functional material-containing layer 113 to the area of the surface of the partition walls 106 that form the flow paths inside the cells 104. For image analysis, on an image taken with an optical microscope (50× magnification), a method can be adopted in which the luminance of each pixel constituting the fifth functional material-containing layer and the partition walls is measured, and a binarization process is performed using the average value thereof as a threshold value to distinguish the region of the fifth functional material-containing layer and the partition walls. After distinguishing between the two, by specifying the length of the part where the partition wall is covered with the fifth functional material-containing layer and dividing it by the cell length (length of the honeycomb structure), the ratio of the length of the portion covered by the fifth functional material-containing layer can be determined.

The fifth functional material-containing layer 113 is preferably insulative for the same reason as the first functional material-containing layer 107a and the second functional material-containing layer 107b. The fact that the fifth functional material-containing layer 113 is insulative means that the fifth functional material-containing layer 113 satisfies the following conditions.

A cross-section parallel to the direction in which the flow paths of the honeycomb structure portion extend is cut out from the heater element 100, and the fifth functional material-containing layer 113 covering the surface of the partition wall 106 is exposed. For the surface of the fifth functional material-containing layer 113 covering an arbitrary cell 104, the electrical resistance at 25° C. between two points separated by 3 mm in the direction in which the cell 104 extends is measured for five locations by the shunt method. When the obtained electrical resistance is 1.0×10⁴Ω or more, the fifth functional material-containing layer 113 covering the cell is defined as having insulative property. The fifth functional material-containing layer 113 covering other cells can be measured in the same manner, but if it is clear that the material forming the fifth functional material-containing layer 113 is substantially the same, the results will be the same, so the measurement may be omitted.

The lower limit of the electrical resistance of the fifth functional material-containing layer 113 is preferably 1.0×10⁵Ω or more, more preferably 5.0×10⁵Ω or more when the electrical resistance is measured using the above procedure. Although there is no particular upper limit for the electrical resistance of the fifth functional material-containing layer 113, when the electrical resistance is measured using the above procedure, the range of electrical resistance is usually 5.0×10⁵Ω to 1.0×10⁷Ω, and is typically 1.0×10⁶Ω to 5.0×10⁶Ω.

The functional materials contained in the fifth functional material-containing layer 113 are as described in the description regarding the first functional material-containing layer 107a and the second functional material-containing layer 107b, including the preferred embodiments.

The fifth functional material-containing layer 113 may contain a binder. The binder is as described in the description regarding the first functional material-containing layer 107a and the second functional material-containing layer 107b, including the preferred embodiments.

The fifth functional material-containing layer 113 may further contain a catalyst, for the purpose of purifying components to be removed or increasing the ability of functional materials (including moisture absorbent) to capture components to be removed. The catalyst is as described in the description regarding the first functional material-containing layer 107a and the second functional material-containing layer 107b, including the preferred embodiments.

Although the average thickness of the fifth functional material-containing layer 113 is not limited, it can be, for example, 10 μm or more and 500 μm or less. By setting the lower limit of the average thickness of the fifth functional material-containing layer 113 to 10 μm or more, preferably 20 μm or more, more preferably 30 μm or more, there is an advantage that the functional material can easily perform its functions. By setting the upper limit of the average thickness of the fifth functional material-containing layer 113 to 500 μm or less, preferably 300 μm or less, more preferably 200 μm or less, the opening area of the cell can be kept large, so there is an advantage that ventilation resistance can be kept low.

The average thickness of the fifth functional material-containing layer 113 is measured by the following procedure. First, a cross-sectional image of the fifth functional material-containing layer 113 is obtained using a scanning electron microscope or the like at a magnification of approximately 50 times. The cross-section is parallel to the direction in which the flow paths of the honeycomb structure portion extend. In the cross-sectional image, as illustrated in the partially enlarged view of FIG. 1B, since the fifth functional material-containing layer 113 is visible at two locations sandwiching each partition wall, the thickness of each fifth functional material-containing layer 113 is calculated by dividing the entire cross-sectional area of the fifth functional material-containing layer 113 from the first end surface 101a to the second end surface 101b by the length from the first end surface 101a to the second end surface 101b of the partition wall that is covered by the fifth functional material-containing layer. Then, a large number of cross-sectional images of the fifth functional material-containing layer 113 are uniformly acquired from the heater element, and the thickness of the fifth functional material-containing layer 113 at five or more locations is measured. The average value of all the measured thicknesses of the fifth functional material-containing layer 113 is defined as the average thickness of the fifth functional material-containing layer.

It should be noted the above-mentioned classifications of the various functional material-containing layers from the first to the fifth are for convenience. Therefore, it is not necessary that separate layers be formed, and there is no hindrance to functional material-containing layers of different classifications being continuous, and there is no hindrance to functional material-containing layers of different classifications being formed simultaneously in a single process.

### (1-7. Current-Carrying Components)

The first terminal 109a and the second terminal 109b can be connected to current-carrying components 105a and 105b, respectively. Examples of conductive materials constituting the current-carrying components 105a and 105b include stainless steel, aluminum, aluminum alloy, copper alloy, and copper. The connection method between the first terminal 109a and the current-carrying component 105a and between the second terminal 109b and the current-carrying component 105b is not particularly limited as long as both are electrically conductive, and for example, the connection can be made by welding, brazing, mechanical contact, or the like. In one embodiment, the current-carrying components 105a and 105b may be an electric wire itself between a power source and the first terminal 109a (second terminal 109b), that is, a copper wire, a copper alloy wire, an aluminum wire, an aluminum alloy wire, or a stainless-steel wire. In another embodiment, the current-carrying components 105a and 105b may be intermediary components that connect an electric wire and the first terminal 109a (second terminal 109b). The intermediary component can be connected to the electric wire by, for example, welding, soldering, brazing, caulking, bolting, or other methods.

(2. Heater Element Assembly Equipped with an Outer Peripheral Surface Holding Type Frame Body)

A heater element according to one embodiment of the invention is provided as a heater element assembly held in a frame body. The protective effect of the frame body prevents the heater element from being damaged when it is installed in a ventilation duct. Further, it is possible to form a shape that is easy to install in an air conditioning system while ensuring electrical insulation with surrounding components.

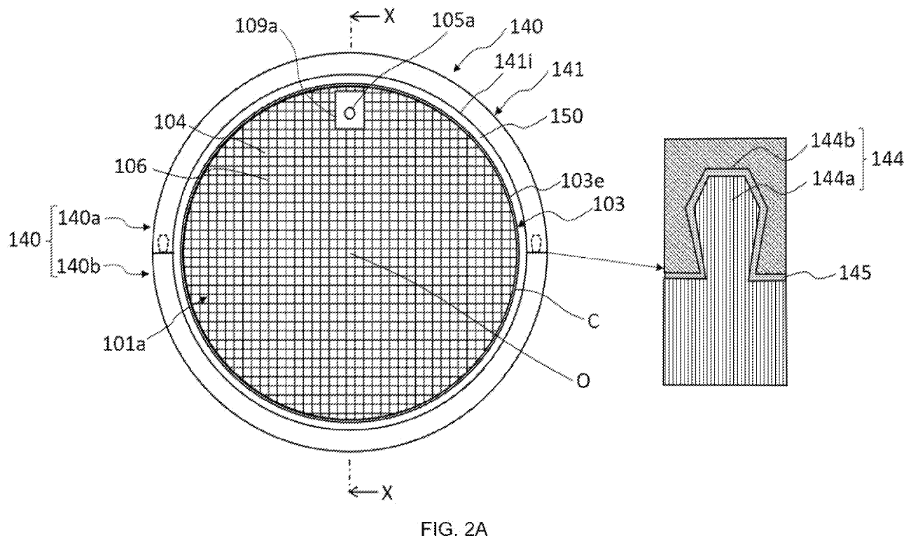

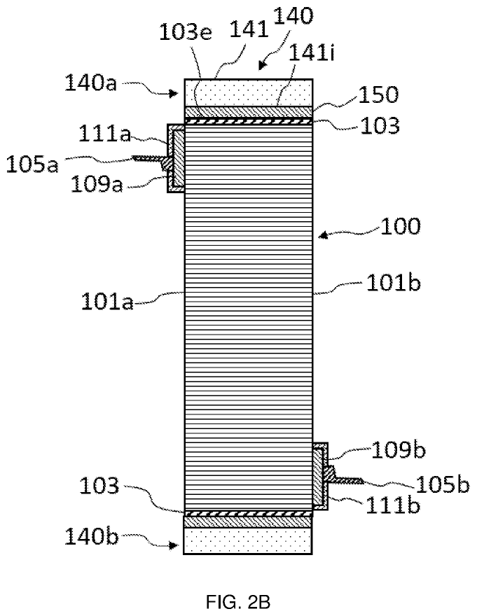

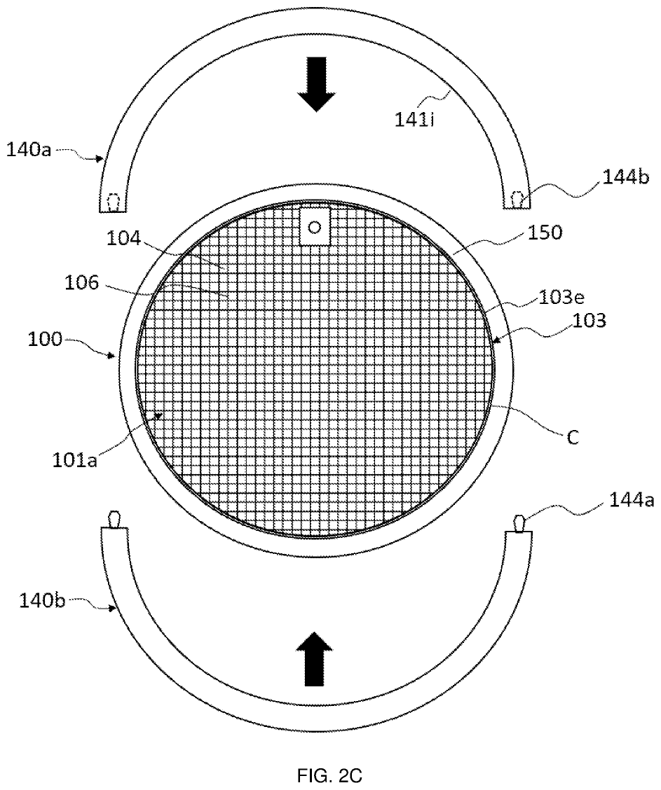

FIGS. 2A and 2B show an example of a heater element assembly including a frame body 140 that holds the heater element 100 from the outer peripheral surface side of the outer peripheral wall 103. The frame body 140 has a first frame portion 141 made of resin and having an inner peripheral surface 141i that fits with the outer peripheral surface 103e of the outer peripheral wall 103 of the honeycomb structure portion with a cushioning material 150 interposed therebetween. With this configuration, the frame body 140 can hold the heater element 100 while suppressing damage to the honeycomb structure portion. Further, the cushioning material 150 can also deform following the thermal deformation of the heater element 100 to relieve thermal stress. This makes it possible to suppress the occurrence of cracks in the heater element 100.

From the viewpoint of stably holding the heater element 100 and increasing the protection performance for the heater element 100, it is preferable that the frame body 140 has a first frame portion 141 made of resin and having an inner peripheral surface 141i that fits with the entire outer peripheral surface 103e of the outer peripheral wall 103 of the honeycomb structure portion via a cushioning material 150.

In one embodiment, the frame body 140 shown in FIGS. 2A and 2B can be provided as a tubular, integral part. Alternatively, the frame body 140 may be formed by connecting two parts that have been separated from each other. When the frame bodies 140 are separated from each other, the methods for connecting them include, but are not limited to, a method of connecting with a fastener, a method of connecting with a fitting structure, and a method of connecting with an adhesive.

The frame body 140 shown in FIGS. 2A and 2B may be formed by connecting a pair of half-split members 140a and 140b from a direction perpendicular to the direction in which the flow paths of the honeycomb structure portion extend. FIG. 2C shows a pair of half-split members 140a and 140b approaching from a direction perpendicular to the direction in which the flow paths of the honeycomb structure portion extend, with the heater element 100 interposed therebetween.

The schematic partial enlarged sectional view of FIG. 2A shows a pair of half-split members 140a, 140b connected by a connecting portion 144 having a fitting structure. The illustrated connecting portion 144 has a press-fit convex portion 144a and a concave portion 144b. When the convex portion 144a is pushed into the concave portion 144b while being elastically deformed, the connected state is maintained by the restoring force of the convex portion 144a and the concave portion 144b. The connecting portion 144 can have a snap-fit type or other fitting structure in addition to the press-fit type. It is preferable to sandwich a cushioning material 145 between the pair of half-split members 140a and 140b. The cushioning material 145 compressed by being sandwiched between them plays the role of a spring due to elastic deformation, and can prevent loosening of the connection between the pair of half-split members 140a and 140b.

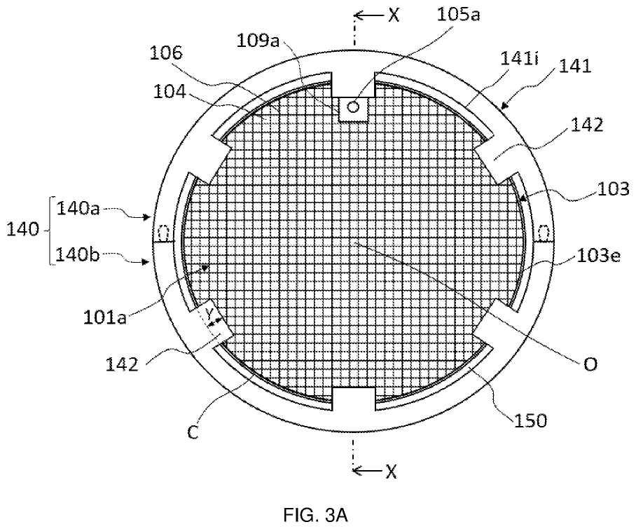

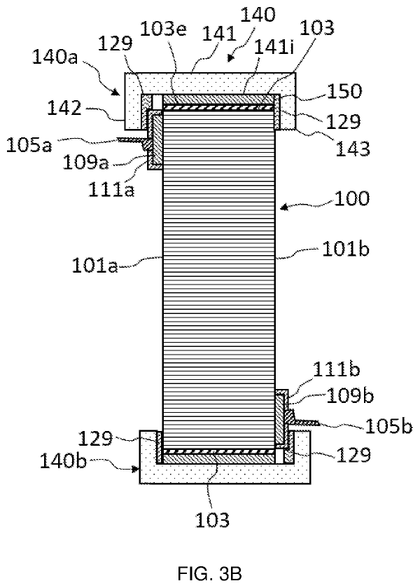

FIGS. 3A and 3B show another example of a heater element assembly including a frame body 140 that holds the heater element 100 from the outer peripheral surface side of the outer peripheral wall 103. The frame body 140 shown in FIGS. 3A and 3B is different from the frame body 140 shown in FIGS. 2A and 2B in that, in addition to the first frame portion 141, they further have a second frame portion 142 that extends toward the inner peripheral side of the outer peripheral contour C of the first end surface 101a and surrounds at least a part of the outer peripheral portion of the first end surface 101a, and a third frame portion 143 that extends toward the inner peripheral side of the outer peripheral contour C of the second end surface 101b and surrounds at least a part of the outer peripheral portion of the second end surface 101b. The second frame portion 142 and the third frame portion 143 can be extended from the first frame portion 141. When the second frame portion 142 and the third frame portion 143 extend from the first frame portion 141, the second frame portion 142 and the third frame portion 143 can also serve as a baffle to prevent a gas bypass flow from occurring at a location where the cushioning material 150 is omitted, if the cushioning material 150 is partially omitted due to the presence of corners in the heater element 100.

In this specification, assuming the coordinate value of the center of gravity O of the first end surface 101a (second end surface 101b) is 0, a coordinate axis is taken in the direction from the center of gravity O toward the outer peripheral contour C of the first end surface 101a (second end surface 101b), and the coordinate value on the outer peripheral contour C is assumed to be 1.00R. Then, a set of points located between 0.90R and 1.00R is defined as the outer peripheral portion of the first end surface 101a (second end surface 101b).

By including the second frame portion 142 and the third frame portion 143 in the frame body 140, there is an effect of preventing the heater element 100 from moving and detaching from the frame body 140 in the direction in which the flow paths extend. The second frame portion 142 (third frame portion 143) does not need to contact the surface of the heater element 100 on the first end surface 101a (second end surface 101b) side, but it is preferable to have a portion that presses the first terminal 109a (second terminal 109b) toward the first end surface 101a (second end surface 101b). In that case, the second frame portion 142 (third frame portion 143) may be configured to press the first terminal 109a (second terminal 109b) toward the first end surface 101a (second end surface 101b) via the cushioning material 129.

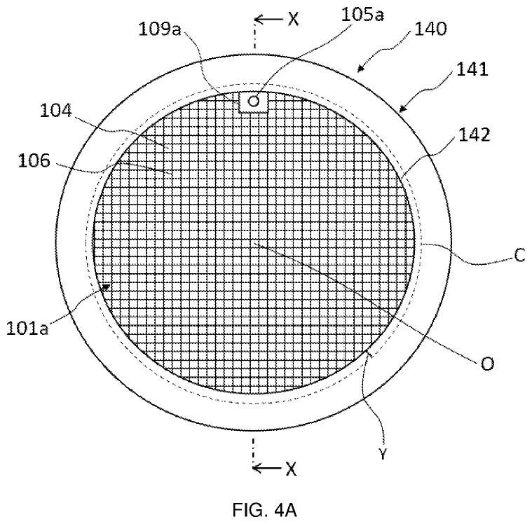

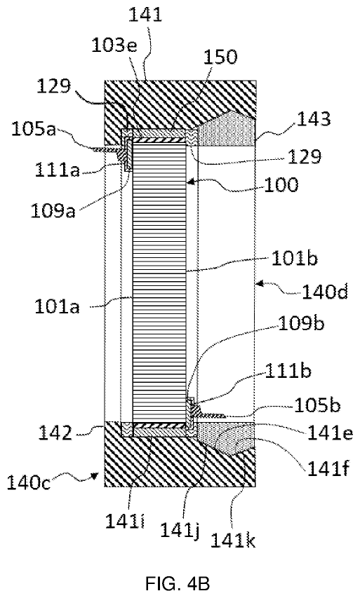

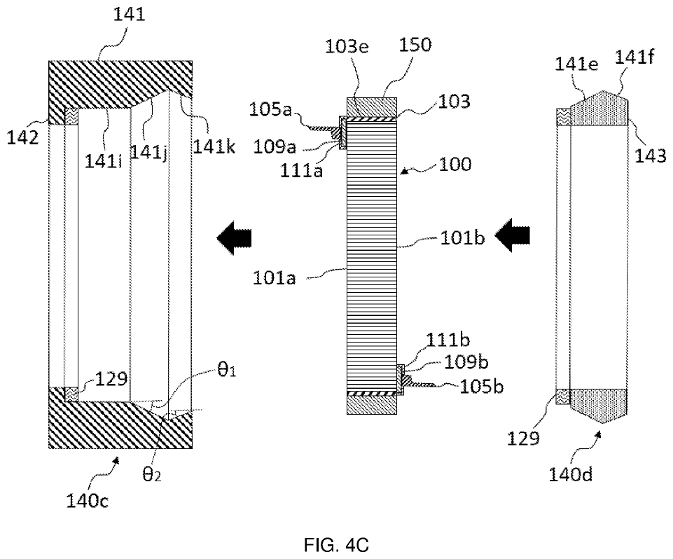

The second frame portion 142 (third frame portion 143) may be made to locally protrude inward at one or more locations, such that the outer peripheral portion of the first end surface 101a (second end surface 101b) is partially surrounded. When the second frame portion 142 (third frame portion 143) is provided at multiple locations so as to locally protrude inward, when the heater element assembly is viewed from the first end surface 101a (second end surface 101b) side, it is preferably provided at equal intervals in the peripheral direction of the first end surface 101a (second end surface 101b), and/or at 4 to 8 locations symmetrically with the center of gravity O as the center of symmetry (see FIG. A). Alternatively, the second frame portion 142 (third frame portion 143) may surround the entire outer peripheral portion of the first end surface 101a (second end surface 101b) as shown in FIG. 4A.

Of the outer surface of the first terminal 109a (second terminal 109b), if the area ratio of the portion pressed toward the first end surface 101a (second end surface 101b) by the second frame portion 142 (third frame portion 143) is large, the effect of preventing the first end surface 101a (second end surface 101b) from falling off is improved. Accordingly, the lower limit of the area ratio is preferably 10% or more, more preferably 15% or more, and even more preferably 20% or more. On the other hand, the smaller the ratio of the area is, the easier it is to secure a space for the current-carrying components, and the easier it is to join the current-carrying components 105a (105b). Accordingly, the upper limit of the area ratio is preferably 80% or less, more preferably 75% or less, and even more preferably 70% or less. Therefore, the range of the area ratio can be, for example, 10 to 80%.

From the viewpoint of not obstructing the flow of gas flowing in and out of the heater element 100, the upper limit of the width Y of the area where the second frame portion 142 (third frame portion 143) surrounds the first end surface 101a (second end surface 101b) is preferably 10 mm or less, more preferably 7 mm or less, and even more preferably 5 mm or less. Further, from the viewpoint of improving the holding performance for the heater element 100, the lower limit of the width Y of the area where the second frame portion 142 (third frame portion 143) surrounds the first end surface 101a (second end surface 101b) is preferably 1 mm or more, more preferably 2 mm or more, and even more preferably 3 mm or more. Therefore, the range of the width Y of the area where the second frame portion 142 (third frame portion 143) surrounds the first end surface 101a (second end surface 101b) can be, for example, 1 mm or more and 10 mm or less. Here, the width Y of the area where the second frame portion 142 (third frame portion 143) surrounds the first end surface 101a (second end surface 101b) means the length of the second frame portion 142 (third frame portion 143) in the direction from the outer peripheral contour C of the first end surface 101a (second end surface 101b) toward the center of gravity O of the first end surface 101a (second end surface 101b).

When the second frame portion 142 (third frame portion 143) is observed from the first end surface 101a (second end surface 101b) side (see FIG. 3A), the upper limit of the ratio of the area of the second frame portion 142 (third frame portion 143) (if there are multiple second frame portions 142 (third frame portions 143), this refers to their total area.) to the area of the first end surface 101a (second end surface 101b) is preferably 10% or less, more preferably 5% or less, and even more preferably 3% or less, from the viewpoint of not obstructing the flow of gas into and out of the heater element 100. On the other hand, from the viewpoint of improving the retention performance for the heater element 100, the lower limit of the ratio of the area of the second frame portion 142 (third frame portion 143) to the area of the first end surface 101a (second end surface 101b) is preferably 0.5% or more, more preferably 1%, and even more preferably 2% or more. Accordingly, the range of the ratio of the area of the second frame portion 142 (third frame portion 143) to the area of the first end surface 101a (second end surface 101b) is, for example, 0.5% or more and 10% or less.

It is preferable that the frame body 140 shown in FIGS. 3A and 3B is formed by connecting two mutually separated parts. This is to facilitate the work of accommodating the heater element 100 in the frame body 140 since the frame body 140 has the second frame portion 142 and the third frame portion 143. When the frame body 140 is divided into two parts, the method of connecting the two parts is not limited, and mention can be made to a method of connecting using a fastener, a method of connecting using a fitting structure, and a method of connecting using an adhesive. In the frame body 140 shown in FIGS. 3A and 3B, a pair of half-split members 140a and 140b are formed by connecting from a direction perpendicular to the direction in which the flow paths of the honeycomb structure portion extend. A specific example of the fitting structure is as shown in FIG. 2A.

The resin constituting the first frame portion 141, preferably resin constituting the second frame portion 142 and the third frame portion 143 in addition to the first frame portion 141, is desirable to have a certain degree of softness so that the heater element 100 is not easily damaged. Therefore, in one embodiment, it is preferable that the resin constituting the first frame portion 141, preferably resin constituting the second frame portion 142 and the third frame portion 143 in addition to the first frame portion 141, have an upper limit of Rockwell hardness measured in accordance with ASTM D785-2008 R15 of 150 HRR or less, more preferably 130 HRR or less, and even more preferably 120 HRR or less. In another embodiment, it is preferable that the resin constituting the first frame portion 141, preferably resin constituting the second frame portion 142 and the third frame portion 143 in addition to the first frame portion 141, have an upper limit of Rockwell hardness measured in accordance with ASTM D785-2008 R15 of 120 HRM or less, more preferably 100 HRM or less, and even more preferably 90 HRM or less. The resin constituting the first frame portion 141, preferably resin constituting the second frame portion 142 and the third frame portion 143 in addition to the first frame portion 141, is possible to satisfy the conditions regarding the upper limit of either one of the Rockwell hardness HRR and HRM described above, and it is desirable to satisfy both conditions.

On the other hand, from the viewpoint of improving the retention performance for the heater element 100, it is desirable that the resin constituting the first frame portion 141, preferably the resin constituting the second frame portion 142 and the third frame portion 143 in addition to the first frame portion 141, has a certain degree of hardness. Therefore, in one embodiment, it is preferable that resin constituting the first frame portion 141, preferably resin constituting the second frame portion 142 and the third frame portion 143 in addition to the first frame portion 141, have a lower limit of Rockwell hardness measured in accordance with ASTM D785-2008 R15 of 70HRR or more, more preferably 80 HRR or more, and even more preferably 90 HRR or more. In another embodiment, it is preferable that the resin constituting the first frame portion 141, preferably resin constituting the second frame portion 142 and the third frame portion 143 in addition to the first frame portion 141, have a lower limit of Rockwell hardness measured in accordance with ASTM D785-2008 R15 of 40 HRM or more, is more preferably 50 HRM or more, and even more preferably 70 HRM or more. The resin constituting the first frame portion 141, preferably resin constituting the second frame portion 142 and the third frame portion 143 in addition to the first frame portion 141, is possible to satisfy the conditions regarding the lower limit of either one of the Rockwell hardness HRR and HRM described above, and it is desirable to satisfy both conditions.

Therefore, in one embodiment, the resin constituting the first frame portion 141, preferably resin constituting the second frame portion 142 and the third frame portion 143 in addition to the first frame portion 141, has a range of Rockwell hardness measured in accordance with ASTM D785-2008 R15 of, for example, 70 HRR or more and 150 HRR or less. In another embodiment, the resin constituting the first frame portion 141, preferably resin constituting the second frame portion 142 and the third frame portion 143 in addition to the first frame portion 141, has a range of Rockwell hardness measured in accordance with ASTM D785-2008 R15 of, for example, 40 HRM or more and 120 HRM or less.

There are no particular restrictions on the type of resin that constitutes the first frame portion 141, second frame portion 142, and third frame portion 143, but from the viewpoint of heat resistance and corrosion resistance, it is preferable that the first frame portion 141, preferably the second frame portion 142 and the third frame portion 143 in addition to the first frame portion 141, contain one or both of polyetheretherketone (PEEK) and polybutylene terephthalate (PBT), more preferably the total content of polyetheretherketone (PEEK) and polybutylene terephthalate (PBT) is 80% by mass or more, even more preferably 90% by mass or more, and may be 100% by mass.

It is desirable that the resin constituting the first frame portion 141, preferably the second frame portion 142 and the third frame portion 143 in addition to the first frame portion 141, have heat resistance. Therefore, it is preferable that the first frame portion 141, preferably the second frame portion 142 and the third frame portion 143 in addition to the first frame portion 141, have a lower limit of the deflection temperature under load measured in accordance with JIS K7191-1:2015 of 145° C. or higher, more preferably 160° C. or higher, and even more preferably 180° C. or higher. Although the upper limit of the deflection temperature under load is not particularly set, from the viewpoint of availability, it is usually 300° C. or lower, and typically 250° C. or lower. Accordingly, the resin constituting at least one, preferably both, of the first frame portion 141 and the second frame portion 142 has a deflection temperature under load of, for example, 145° C. or more and 300° C. or less.

It is desirable that the resin constituting the first frame portion 141, preferably the second frame portion 142 and the third frame portion 143 in addition to the first frame portion 141, have a high melting point so as not to melt when heated. Accordingly, it is preferable that the first frame portion 141, preferably the second frame portion 142 and the third frame portion 143 in addition to the first frame portion 141, have a lower limit of the melting point of preferably 250° C. or higher, more preferably 280° C. or higher, and even more preferably 300° C. or higher. The upper limit of the melting point is not particularly set, but from the viewpoint of availability, it is usually 400° C. or lower, typically 350° C. or lower. The resin constituting the first frame portion 141, preferably the second frame portion 142 and the third frame portion 143 in addition to the first frame portion 141, has a melting point range of, for example, 250° C. or more and 400° C. or less.

In this specification, the melting point of a resin refers to the lowest temperature at which an endothermic peak due to melting is observed when TG-DTA (thermogravimetry-differential thermal analysis) measurement is performed.

It is desirable that the resin constituting the first frame portion 141, preferably the second frame portion 142 and the third frame portion 143 in addition to the first frame portion 141, has a low thermal conductivity in order to reduce heat loss. Therefore, it is preferable that the resin constituting the first frame portion 141, preferably the second frame portion 142 and the third frame portion 143 in addition to the first frame portion 141, have an upper limit of thermal conductivity at 25° C. measured in accordance with JIS R1611: 2010 of 0.5 W/m/K or less, more preferably 0.3 W/m/K or less, and even more preferably 0.2 W/m/K or less. The lower limit of thermal conductivity is not particularly set, but from the viewpoint of availability, it is usually 0.1 W/m/K or more, typically 0.15 W/m/K or more. Therefore, the resin constituting the first frame portion 141, preferably the resin constituting the second frame portion 142 and the third frame portion 143 in addition to the first frame portion 141, have a thermal conductivity range of, for example, 0.1 W/m/K or more and 0.5 W/m/K or less.

The resin forming the first frame portion 141, preferably the second frame portion 142 and the third frame portion 143 in addition to the first frame portion 141, is preferably insulative in order to suppress short circuits. Therefore, it is preferable that the resin forming the first frame portion 141, preferably the second frame portion 142 and the third frame portion 143 in addition to the first frame portion 141, have a lower limit of the volume resistivity at 25° C. measured according to the bridge method of JIS C 2139:2008 of 1.0×10¹⁶ Ω·cm or more, preferably 2.0×10¹⁶ Ω·cm or more, and more preferably 5.0×10¹⁶ Ω·cm or more. Although the upper limit of the volume resistivity is not particularly set, from the viewpoint of availability, it is usually 1.0×10¹⁸ Ω·cm or less, and typically 1.0×10¹⁷ Ω·cm or less. Therefore, the resin constituting the first frame portion, preferably the second frame portion 142 and the third frame portion 143 in addition to the first frame portion 141, has a volume resistivity of, for example, 1.0×10¹⁶ Ω·cm or more and 1.0×10¹⁸ Ω·cm or less.

The thickness in the compression direction of the cushioning material 150 when compressed by being sandwiched and receiving pressure between the inner peripheral surface 141i of the first frame portion 141 and the outer peripheral surface 103e of the outer peripheral wall 103 of the honeycomb structure portion preferably has a lower limit of 0.5 mm or more, more preferably 1.0 mm or more, and even more preferably 2.0 mm or more, from the viewpoint of ensuring a deformation margin to obtain a sufficient cushioning effect. The thickness in the compression direction of the cushioning material 150 when compressed by being sandwiched and receiving pressure between the inner peripheral surface 141i of the first frame portion 141 and the outer peripheral surface 103e of the outer peripheral wall 103 of the honeycomb structure portion preferably has an upper limit of 7.0 mm or less, more preferably 5.0 mm or less, and even more preferably 4.0 mm or less, from the viewpoint of compactness and reducing the space required for mounting. Accordingly, the range of thickness in the compression direction of the cushioning material 150 when compressed by being sandwiched and receiving pressure between the inner peripheral surface 141i of the first frame portion 141 and the outer peripheral surface 103e of the outer peripheral wall 103 of the honeycomb structure portion can be, for example, 0.5 mm or more and 7.0 mm or less.

The thickness in the compression direction of the cushioning material 129 when compressed by receiving pressure from the second frame portion 142 (third frame portion 143) preferably has a lower limit of 0.5 mm or more, more preferably 1.0 mm or more, and even more preferably 2.0 mm or more, from the viewpoint of ensuring a deformation margin to obtain a sufficient cushioning effect. The thickness in the compression direction of the cushioning material 129 when compressed by receiving pressure from the second frame portion 142 (third frame portion 143) preferably has an upper limit of 7.0 mm or less, more preferably 5.0 mm or less, and even more preferably 4.0 mm or less, from the viewpoint of compactness and reducing the space required for mounting. Therefore, the range of the thickness in the compression direction of the cushioning material 129 when compressed by receiving pressure from the second frame portion 142 (third frame portion 143) can be, for example, 0.5 mm or more and 7.0 mm or less.

The lower limit of the pressure that the cushioning material 129 receives from the second frame portion 142 (third frame portion 143) is preferably 0.002 MPa or more, and more preferably 0.005 MPa or more. The upper limit of the pressure that the cushioning material 129 receives from the second frame portion 142 (third frame portion 143) is preferably 0.2 MPa or less, more preferably 0.1 MPa or less. Therefore, the pressure that the cushioning material 129 receives from the second frame portion 142 (third frame portion 143) is preferably 0.002 MPa to 0.2 MPa, and more preferably 0.005 MPa to 0.1 MPa. The pressure that the cushioning material 129 receives from the second frame portion 142 (third frame portion 143) is determined from the Young's modulus and displacement amount of the cushioning material 129.

The lower limit of the Young's modulus of the cushioning material 150 and the cushioning material 129 is preferably 0.05 MPa or more, more preferably 0.06 MPa or more, and even more preferably 0.1 MPa or more, from the viewpoint of ensuring the holding force for the honeycomb heater element. The upper limit of the Young's modulus of the cushioning material 150 and the cushioning material 129 is preferably 0.3 MPa or less, more preferably 0.25 MPa or less, and even more preferably 0.2 MPa or less, from the viewpoint of ensuring a deformation margin to obtain a sufficient cushioning effect. Therefore, the range of the Young's modulus of the cushioning material 150 and the cushioning material 129 can be, for example, 0.05 MPa or more and 0.3 MPa or less.

The Young's modulus of the cushioning material 150 and the cushioning material 129 is determined from the relationship between the surface pressure and thickness change (displacement amount) when the sheet-like cushioning material is compressed by gradually applying surface pressure.

There are no particular restrictions on the types of materials constituting the cushioning material 150 and the cushioning material 129, but from the viewpoint of ensuring sufficient deformation allowance, it is preferable that they are made of rubber, and more preferably that they are made of rubber sponge. Rubber and rubber sponge may contain various rubbers such as natural rubber, styrene/butadiene rubber, butadiene rubber, chloroprene rubber, ethylene/propylene rubber, butyl rubber, fluororubber, acrylonitrile/butadiene rubber, silicone rubber, isoprene rubber, urethane rubber, chlorosulfonated polyethylene, hydrogenated nitrile rubber, epichlorohydrin rubber, acrylic rubber, ethylene acrylic rubber, norbornene rubber. These may be contained singly or in a mixture of two or more. Among these, it is more preferable that the cushioning material 150 is made of silicone rubber sponge whose main component is silicone rubber (preferably 60% by mass or more, more preferably 80% by mass or more).

The lower limit of the Young's modulus of the cushioning material 145 is preferably 0.05 MPa or more, more preferably 0.06 MPa or more, and even more preferably 0.1 MPa or more, from the viewpoint of ensuring the holding surface pressure for the convex portions 144a and the concave portions 144b. The upper limit of the Young's modulus of the cushioning material 145 is preferably 0.3 MPa or less, more preferably 0.25 MPa or less, and even more preferably 0.2 MPa or less, from the viewpoint of ensuring a deformation margin to obtain a sufficient cushioning effect. Therefore, the range of the Young's modulus of the cushioning material 145 can be, for example, 0.05 MPa or more and 0.3 MPa or less.

The method for measuring the Young's modulus of the cushioning material 145 is as described in the description of the cushioning material 150.

The materials constituting the cushioning material 145 are as described in the description of the cushioning material 150, including the preferred embodiments.

As a method of forming the frame body 140 by connecting two parts that have been mutually separated from each other, it is also possible to connect the two parts in the direction parallel to the direction in which the flow paths of the honeycomb structure portion extend. FIGS. 4A and 4B show a further example of a heater element assembly including a frame body 140 that holds the heater element 100 from the outer peripheral surface side of the outer peripheral wall 103. The frame body 140 shown in FIGS. 4A and 4B also has a first frame portion 141 made of resin and having an inner peripheral surface 141i that fits with the outer peripheral surface 103e of the outer peripheral wall 103 of the honeycomb structure portion via the cushioning material 150. Further, in addition to the first frame portion 141, the frame body 140 shown in FIGS. 4A and 4B may further have a second frame portion 142 that extends toward the inner peripheral side of the outer peripheral contour C of the first end surface 101a and surrounds at least a part of the outer peripheral portion of the first end surface 101a, and a third frame portion 143 that extends toward the inner peripheral side of the outer peripheral contour C of the second end surface 101b and surrounds at least a part of the outer peripheral portion of the second end surface 101b.

The frame body 140 shown in FIGS. 4A and 4B can be formed by connecting a first tubular divisional portion 140c made of resin and having a first frame portion 141, and a second tubular divisional portion 140d made of resin and having an outer peripheral surface that can fit with the inner peripheral surface of the first tubular divisional portion 140c, from a direction parallel to the direction in which the flow paths of the honeycomb structure portion extend. FIG. 4C shows how the first tubular divisional portion 140c and the second tubular divisional portion 140d approach from a direction parallel to the direction in which the flow paths of the honeycomb structure portion extend, with the heater element 100 interposed therebetween. In the frame body 140 shown in FIGS. 4A and 4B, the first tubular divisional portion 140c has a second frame portion 142 in addition to the first frame portion 141, and the second tubular divisional portion 140d has a third frame portion 143.

In the frame body 140 shown in FIGS. 4A and 4B, the inner peripheral surface of the first tubular divided portion 140c has a first inner peripheral surface 141i that fits with the outer peripheral surface 103e of the outer peripheral wall 103 of the honeycomb structure portion via a cushioning material 150; a second inner peripheral surface 141j that is connected to one end of the first inner peripheral surface 141i and whose diameter increases as the distance increase from the one end of the first inner peripheral surface 141i (inversely tapered); and a third inner peripheral surface 141k that is connected to one end of the second inner peripheral surface 141j and whose diameter decreases as the distance increases from the one end of the second inner peripheral surface 141j (tapered), in this order. Further, the outer peripheral surface of the second tubular divisional portion 140d has a first outer peripheral surface 141e that fits with the second inner peripheral surface 141j, and a second outer peripheral surface 141f that fits with the third inner peripheral surface 141k. The diameter of the first outer peripheral surface 141e increases as the distance increases from the second end surface 101b of the heater element 100. The second outer peripheral surface 141f is connected to one end of the first outer peripheral surface 141e, and its diameter decreases as the distance increases from the one end of the first outer peripheral surface 141e.

Referring to FIG. 4C, the angle θ₁ formed by the second inner peripheral surface 141j with respect to the direction in which the flow paths of the honeycomb structure portion extend can be, for example, 0.5° to 2.0°, preferably 0.8° to 1.3°, and more preferably 0.9° to 1.2°. Further, the angle θ₂ formed by the third inner peripheral surface 141k with respect to the direction in which the flow paths of the honeycomb structure portion extend can be, for example, 1.0° to 3.0°, preferably 1.6° to 2.5°, and more preferably 1.7° to 2.4°.

If the first tubular divisional portion 140c has the reversely tapered second inner peripheral surface 141j, when fitting the heater element 100 with the outer peripheral wall 103 covered with the cushioning material 150 into the first tubular divisional portion 140c, the cushioning material 150 can be gradually compressed, and a smooth fitting operation can be realized. Furthermore, if the first tubular divisional portion 140c has the second inner peripheral surface 141j having a reverse tapered shape, it is possible to smoothly perform the operation of fitting the second tubular divisional portion 140d into the first tubular divisional portion 140c by elastic deformation. Furthermore, if the first tubular divisional portion 140c has the tapered third inner peripheral surface 141k, and the second tubular divisional portion 140d has the second outer peripheral surface 141f that fits with the third inner peripheral surface 141k, it is possible to firmly connect the first tubular divisional portion 140c and the first tubular divisional portion 140c.

Regarding the already mentioned components such as the first frame portion 141, the second frame portion 142, the third frame portion 143, the cushioning material 150, and the cushioning material 129 in the frame body 140 shown in FIGS. 4A and 4B are as described with respect to the frame body 140 shown in FIGS. 2A and 2B and the frame body 140 shown in FIGS. 3A and 3B, including preferred embodiments, unless otherwise specified. Therefore, duplicate explanations are omitted.

In the heater element assembly according to any of the above embodiments, in order to securely fix the heater element 100, it is preferable that the inner peripheral surface 141i of the first frame portion 141 is fitted with the outer peripheral surface 103e of the outer peripheral wall 103 of the honeycomb structure portion part with a strong frictional force via the cushioning material 150. Specifically, the load required to push out the heater element 100 from the first frame portion 141 (referred to as “push-out load”), which is a load applied to the heater element 100 held in the first frame body 141 in the direction parallel to the direction in which the flow paths of the honeycomb structure portion extend, preferably has a lower limit of 15N or more, more preferably 20N or more, and even more preferably 25N or more. Although there is no particular upper limit for the punch-out load, if the heater element 100 is excessively tightened in an attempt to increase the punch-out load, there is a risk that the heater element will be damaged. Therefore, the upper limit of the push-out load is preferably 80N or less, more preferably 70N or less, and even more preferably 60N or less. The push-out load can be adjusted by, for example, the material of the cushioning material 150, the inner diameter of the first frame portion 141, the coefficient of friction, and the like.

The push-out load is measured using the following procedure. The heater element assembly is placed so that the direction in which the cells extend is vertical, and both ends of the first frame portion are sandwiched in the direction in which the cells extend. A circular thin plate (SUS material or the like) with a rigidity that can be ignored regarding the load is installed in the center of one end of the heater element assembly. The heater element is pushed out from the first frame portion by applying a push-out load using a load cell for a universal test (for example, 68FM-30 manufactured by Instron). At this time, the highest value of the load from the load-displacement graph is read and used as the measured value.

In addition, when the second frame portion and the third frame portion exist, the measurement of the above-mentioned punching load is performed after removing the second frame portion and the third frame portion which are present in the front in the punching direction.

### (3. Manufacturing Method of Heater Element)

Next, a method for manufacturing a heater element according to the present invention will be exemplified.

The method for manufacturing the honeycomb structure portion that constitutes the heater element includes a forming process and a firing process.

In the forming step, a green body containing ceramic raw materials including BaCO₃ powder, TiO₂ powder, and rare earth nitrate or hydroxide powder is formed to prepare a honeycomb formed body having a relative density of 60% or more.

The ceramic raw material can be obtained by dry mixing each powder to obtain a desired composition.

The green body can be obtained by adding a dispersion medium, a binder, a plasticizer, and a dispersant to the ceramic raw material and kneading the mixture. The green body may contain additives such as a shifter, a metal oxide, a property improving agent, and a conductive powder, if necessary.

The contents of components other than the ceramic raw material is not particularly limited as long as the relative density of the honeycomb formed body is 60% or more.

Here, in this specification, the “relative density of the honeycomb formed body” means the ratio of the density of the honeycomb formed body to the true density of the entire ceramic raw material. Specifically, it can be determined by the following formula:

Relative density of honeycomb formed body (%)=Density of honeycomb formed body (g/cm³)/True density of entire ceramic raw material (g/cm³)×100

The density of the honeycomb formed body can be measured by the Archimedes method using pure water as a medium. Further, the true density of the entire ceramic raw material can be determined by dividing the total mass (g) of each raw material by the total solid volume (cm³) of each raw material.

As the dispersion medium, mention can be made to water or a mixed solvent of water and an organic solvent such as alcohol, and water is particularly preferably used.

As the binder, examples include organic binders such as methylcellulose, hydroxypropylcellulose, hydroxyethylcellulose, carboxymethylcellulose, and polyvinyl alcohol. In particular, it is suitable to use methyl cellulose and hydroxypropoxy cellulose in combination. One type of binder may be used alone or two or more types may be used in combination, but it is preferable that the binder does not contain an alkali metal element.

As the plasticizer, examples include polyoxyalkylene alkyl ether, polycarboxylic acid polymer, and alkyl phosphate ester.

As the dispersant, surfactants such as polyoxyalkylene alkyl ether, ethylene glycol, dextrin, fatty acid soap, and polyalcohol can be used. As the dispersant, one type may be used alone, or two or more types may be used in combination.

The honeycomb formed body can be produced by extrusion molding the green body. For extrusion molding, a die having a desired overall shape, cell shape, partition wall thickness, cell density, and the like can be used.

The lower limit of the relative density of the honeycomb formed body obtained by extrusion molding is preferably 60% or more, more preferably 65% or more. By controlling the relative density of the honeycomb formed body within such a range, it becomes possible to make the honeycomb formed body dense and reduce the electrical resistance at room temperature. In addition, the upper limit of the relative density of the honeycomb formed body is not particularly limited, but is generally 80% or less, preferably 75% or less.

The honeycomb formed body can be dried before the firing process. The drying method is not particularly limited, and for example, conventionally known drying methods such as hot wind drying, microwave drying, dielectric drying, reduced pressure drying, vacuum drying, and freeze drying can be used. Among these, a drying method that combines hot wind drying with microwave drying or dielectric drying is preferred because the entire formed body can be dried quickly and uniformly.

The firing step includes holding the temperature at 1150 to 1250° C., then raising the temperature to a maximum temperature of 1360 to 1430° C. at a temperature rising rate of 20 to 600° C./hour, and holding the temperature for 0.5 to 10 hours.

By holding the honeycomb formed body at a maximum temperature of 1360 to 1430° C. for 0.5 to 10 hours, it is possible to obtain a honeycomb structure portion whose main component is BaTiO₃-based crystal grains in which a part of Ba is replaced with a rare earth element.

Further, by maintaining the temperature at 1150 to 1250° C., Ba₂TiO₄ crystal grains generated during the firing process are easily removed, so that the honeycomb structure portion can be made denser.

Furthermore, by increasing the temperature from 1150 to 1250° C. to the maximum temperature of 1360 to 1430° C. at a rate of 20 to 600° C./hour, 1.0 to 10.0% by mass of Ba₆Ti₁₇O₄₀ crystal grains can be generated in the honeycomb structure portion.

The holding time at 1150 to 1250° C. is not particularly limited, but is preferably 0.5 to 10 hours. With such a holding time, Ba₂TiO₄ crystal grains generated during the firing process can be easily removed stably.

The firing step preferably includes holding the temperature at 900 to 950° C. for 0.5 to 5 hours. By holding the temperature at 900 to 950° C. for 0.5 to 5 hours, BaCO₃ is efficiently decomposed and a honeycomb structure portion having a predetermined composition is easily obtained.

In addition, a degreasing process for removing the binder may be performed before the firing process. The atmosphere in the degreasing step is preferably atmospheric in order to completely decompose the organic components.

Furthermore, the atmosphere in the firing step is preferably atmospheric from the viewpoint of controlling electrical characteristics and manufacturing cost.

The firing furnace used in the firing process and the degreasing process is not particularly limited, but an electric furnace, a gas furnace, and the like can be used.

By joining a pair of electrode layers (first electrode layer 102a and second electrode layer 102b) to the honeycomb structure portion obtained in this way, a heater element can be manufactured. The first electrode layer 102a and the second electrode layer 102b can be formed on the first end surface 101a and the second end surface 101b of the honeycomb structure portion by a metal deposition method such as sputtering, vapor deposition, electrolytic deposition, or chemical deposition. Further, the first electrode layer 102a and the second electrode layer 102b can also be formed by applying an electrode paste to the first end surface 101a and the second end surface 101b of the honeycomb structure portion and then baking the paste. Furthermore, they can also be formed by thermal spraying. The first electrode layer 102a and the second electrode layer 102b may be composed of a single layer, but may also be composed of a plurality of electrode layers having different compositions. When forming the first electrode layer 102a and the second electrode layer 102b on the end surfaces by the above method, if the thickness of the electrode layers is set so as not to become excessively large, cells can be prevented from being blocked.

Methods for forming the first electrode layer 102a and the second electrode layer 102b include, but are not limited to, baking of electrode paste, dry plating such as sputtering and vapor deposition, wet plating such as electrolytic deposition and chemical deposition, and joining metal plates or alloy plates. Each method has a suitable thickness range. The thickness can be approximately 5 to 30 μm for baking electrode paste, approximately 100 to 1000 nm for dry plating such as sputtering and vapor deposition, approximately 10 to 100 μm for thermal spraying, and approximately 5 to 30 μm for wet plating such as electrolytic deposition and chemical deposition. Further, when joining metal plates or alloy plates, the thickness of the electrode layer can be about 5 to 100 μm.

Next, a first terminal 109a is connected to the outer surface of the first electrode layer 102a, and a second terminal 109b is connected to the outer surface of the second electrode layer 102b. As described above, methods for connecting the two include welding, brazing, mechanical contact, and the like. Further, when baking the electrode paste for forming the first electrode layer 102a (second electrode layer 102b), the first terminal 109a (second terminal 109b) may be connected by baking at the same time.

Next, as necessary, the current-carrying components 105a and 105b are connected to the first terminal 109a and the second terminal 109b, respectively. As described above, methods for connecting the two include welding, brazing, mechanical contact, and the like.

Next, the first functional material-containing layer 107a covering a part of the outer surface of the first electrode layer 102a and the second functional material-containing layer 107b covering a part of the outer surface of the second electrode layer 102b are formed. In a preferred embodiment, the third functional material-containing layer 111a covering a part of the outer surface of the first terminal 109a and a fourth functional material-containing layer 111b covering a part of the outer surface of the second terminal 109b are further formed. In a more preferred embodiment, the fifth functional material-containing layer 113 is further formed to cover a part or all of the surface of the partition walls 106 that form the flow paths inside the cells 104.

The first functional material-containing layer 107a, the second functional material-containing layer 107b, the third functional material-containing layer 111a, the fourth functional material-containing layer 111b, and the fifth functional material-containing layer 113 may be formed individually, or they can also be formed simultaneously. These functional material-containing layers can be formed simultaneously by, for example, the following steps. The heater element before forming the functional material-containing layers is immersed in a slurry containing a functional material such as a moisture absorbent, a binder, and a dispersion medium for a predetermined time, and excess slurry on the outer peripheral surface of the honeycomb structure portion is removed by blowing and wiping. Thereafter, these functional material-containing layers can be formed by drying the slurry. Drying can be carried out, for example, while heating a heater element to a temperature of about 120 to 600° C. The series of steps of dipping, slurry removal, and drying may be performed only once, but by repeating the steps multiple times, functional material-containing layers with a desired thickness can be provided on the surface of the electrode layer or the like.

Although an organic binder may be used as the binder, it is preferable to use an inorganic binder because there is a concern that smoke will be emitted by heat and components in the smoke will flow into the vehicle interior and deteriorate the vehicle interior environment. Suitable types of inorganic binder are as described above.

The dispersion medium can be water, an organic solvent (for example, toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether), or a mixture thereof.

### (4. Air Conditioning System)

According to one embodiment of the present invention, an air conditioning system is provided that includes the heater element described above. The air conditioning system can be used to improve the interior spaces of various vehicles such as automobiles, as well as buildings such as houses, offices, factories, stores, warehouses, and freezers, and means of transportation such as ships and airplanes.

### (4-1. First Air Conditioning System 1000)

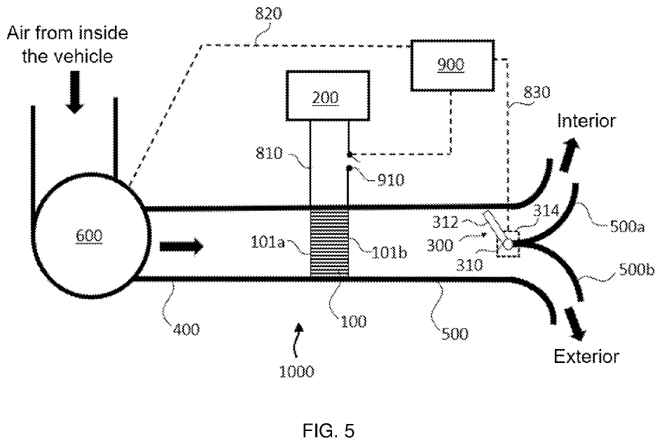

FIG. 5 is a schematic diagram showing the configuration of a first air conditioning system 1000 according to an embodiment of the present invention.

The first air conditioning system 1000 comprises:
a power source 200 such as a battery for applying voltage to the heater element 100;
an inflow pipe 400 that communicates between an interior such as a vehicle interior and an inlet end surface of the heater element 100;
an outflow pipe 500 having a first route 500a that communicates the outlet end surface of the heater element 100 with the interior; and
a ventilator 600 for causing air from the interior to flow into the inlet end surface of the heater element 100 via the inflow pipe 400.

In the air conditioning system shown in FIG. 5, the heater element 100 is arranged such that its inlet end surface is the first end surface 101a and its outlet end surface is the second end surface 101b. However, the heater element 100 can also be arranged such that the inlet end surface is the second end surface 101b and the outlet end surface is the first end surface 101a. Although there may be one heater element 100, a plurality of heater elements 100 may be arranged in series or in parallel.

In addition to the first route 500a, the outflow pipe 500 can have a second route 500b that communicates the outlet end surface of the heater element 100 with the outside of the vehicle or the like. Further, the outflow pipe 500 can include a switching valve 300 that can switch the flow of air flowing through the outflow pipe 500 between the first route 500a and the second route 500b.

The first air conditioning system 1000 may have driving modes of:
a first mode in which the applied voltage from the power supply 200 is turned off, the switching valve 300 is switched so that the air flowing through the outflow pipe 500 passes through the first route 500a, and the ventilation fan 600 is turned on; and
a second mode in which the applied voltage from the power supply 200 is turned on, the switching valve 300 is switched so that the air flowing through the outflow pipe 500 passes through the second route 500b, and the ventilation fan 600 is turned on.

The first air conditioning system 1000 can include a controller 900 that can perform switching between the first mode and the second mode. For example, the controller 900 may be configured to be able to alternately execute the first mode and the second mode. By repeating switching between the first mode and the second mode in a constant cycle, it becomes possible to stably discharge components to be removed, such as indoor water vapor, to the outside of the vehicle.

In the first mode, the component to be removed in the air is removed. Specifically, air from the interior flows in from the inlet end surface of the heater element 100 through the inflow pipe 400, passes through the inside of the heater element 100, and then flows out from the outlet end surface of the heater element 100. The components to be removed from the air from the room are captured by a functional material such as a dehumidifier while passing through the heater element 100, and thereby removed. The air from which the removal target has been removed, which flows out from the outlet end surface of the heater element 100, is returned to the interior through the first route 500a of the outflow pipe 500. The air may also be supplied to other air conditioning systems (for example, HVAC of the vehicle).

In the second mode, functional materials such as dehumidifying materials are regenerated. Specifically, air from the interior flows in from the inlet end surface of the heater element 100 through the inflow pipe 400, passes through the inside of the heater element 100, and then flows out from the outlet end surface of the heater element 100. The heater element 100 generates heat when energized, thereby heating the functional material supported on the heater element 100, so that the component to be removed, which is captured by the functional material, separates from the functional material or reacts.

In order to promote detachment of the component to be removed that is captured by the functional material, it is preferable to heat the functional material to a temperature higher than the detachment temperature depending on the type of the functional material. When using a moisture absorbent as a functional material, it is preferable to heat at least a part, preferably all, of the moisture absorbent to 70 to 150° C., preferably heat to 80 to 140° C., and even more preferably heat to 90 to 130° C. Further, it is desirable that the second mode be carried out for a period of time until the functional material is sufficiently regenerated. Although it depends on the type of functional material, for example, when a moisture absorbent is used as the functional material, it is preferable that the functional material is heated to the above temperature range for 1 to 10 minutes in the second mode, and it is more preferably heated for 2 to 8 minutes, and it is even more preferably heated for 3 to 6 minutes.

In the second mode, the air from the interior flows out from the outlet end surface of the heater element 100 while entraining the components to be removed that have separated from the functional material while passing through the heater element 100. The air containing the component to be removed that flows out from the outlet end surface of the heater element 100 is discharged to the outside through the second route 500b of the outflow pipe 500.

Switching on and off the applied voltage to the heater element 100 is possible by, for example, electrically connecting the power source 200 and the pair of terminals 109a, 109b of the heater element 100 with an electric wire 810, and operating a power switch 910 provided in the middle. The controller 900 may operate the power switch 910.

Switching on and off the ventilation fan 600 is possible by, for example, electrically connecting the controller 900 and the ventilator 600 by an electric wire 820 or wirelessly, and operating a switch (not shown) of the ventilator 600 by the controller 900. The ventilator 600 can also be configured such that the amount of ventilation can be changed by the controller 900.

The switching of the switching valve 300 is possible by, for example, electrically connecting the controller 900 and the switching valve 300 with an electric wire 830 or wirelessly, and operating a switch (not shown) of the switching valve 300 using the controller 900.

The switching valve 300 is not particularly limited as long as it is electrically driven and has the function of switching the flow paths, and examples thereof include a solenoid valve and an electric valve. In one embodiment, the switching valve 300 includes an opening/closing door 312 supported by a rotating shaft 310 and an actuator 314 such as a motor that rotates the rotating shaft 310. The actuator 314 is configured to be controllable by the controller 900.

In the first air conditioning system 1000, from the viewpoint of stably ensuring the above-mentioned functions, it is desirable that the heater element 100 be disposed at a position close to the vehicle interior. Therefore, from the viewpoint of preventing electric shock or the like, it is preferable that the driving voltage is 60 V or less. Since the honeycomb structure portion used in the heater element 100 has low electrical resistance at room temperature, it is possible to heat the honeycomb structure portion with this low driving voltage. In addition, the lower limit of the driving voltage is not particularly limited, but is preferably 10 V or more. If the drive voltage is less than 10V, the electric current when heating the honeycomb structure portion becomes large, so it is necessary to make the electric wire 810 thick. Therefore, the driving voltage of the first air conditioning system 1000 can be, for example, 10V or more and 60V or less.

In the embodiment shown in FIG. 5, the ventilator 600 is installed upstream of the heater element 100. More specifically, the ventilator 600 is installed in the middle of an inflow pipe 400 that communicates the heater element 100 with the interior, and the air that has passed through the ventilator 600 flows in so as to be forced toward the heater element 100. Alternatively, the ventilator 600 may be placed downstream of the heater element 100. In this case, the ventilator 600 can be installed, for example, in the middle of the outflow pipe 500, and the air that has passed through the inflow pipe 400 flows into the heater element 100 so as to be sucked into it.

### EXAMPLES

### [1. Specifications of Honeycomb Structure Portion]

Honeycomb structure portions with the following specifications were prepared.
Shape of the cross-section and end surface of the honeycomb structure portion orthogonal to the direction in which the flow paths extend: Square (curvature radius of 6 mm or more)
Cell opening shape orthogonal to the direction in which the flow paths extend: square with rounded corners
Thickness of the partition walls: 0.100 mm
Thickness of the outer peripheral wall: 0.3 mm
Cell density: 80 cells/cm²
Cell pitch: 1.11 mm
Cell opening ratio: 0.797
Size of cross-section orthogonal to the direction in which the flow paths of the honeycomb structure portion extend: 90 mm×90 mm
Length in the direction in which the flow paths of the honeycomb structure portion extend: 12 mm
Volume resistivity at 25° C. of the material constituting the outer peripheral wall and the partition walls: 15 Ω·cm
Curie point of the material constituting the outer peripheral wall and the partition walls: 120° C.
Material constituting the outer peripheral wall and the partition walls: Barium titanate
Density of the material constituting the outer peripheral wall and the partition walls: 5750 kg/m³
Specific heat of the material constituting the outer peripheral wall and the partition walls: 550 J/kg/K

### [2. Properties of Functional Material (Moisture Absorbent) Used]

Commercially available amorphous aluminum silicate was prepared as a moisture absorbent. After drying at 180° C. for 2 hours or more, 5 g of amorphous aluminum silicate was left in a constant temperature and humidity chamber at room temperature (25° C.) and 50% relative humidity for one hour. The mass (g) of water that can be adsorbed per 1 g of dry mass was determined to be 15 g/g from the increased mass of the amorphous aluminum silicate taken out from the constant temperature and humidity chamber.

After drying at 180° C. for 2 hours or more, 5 g of amorphous aluminum silicate was placed in a constant temperature and humidity chamber with a relative humidity of 50%, and changes in mass were investigated after being left at various temperatures for 1 hour. In this way, the temperature range in which the mass (g) of water that can be adsorbed per gram of dry mass was 5 g/g or more was determined, and it was found to be 10° C. to 25° C.

After drying at 180° C. for 2 hours or more, 5 g of amorphous aluminum silicate was left in a constant temperature and humidity chamber at room temperature (25° C.) and 50% relative humidity for one hour to adsorb moisture. The amorphous aluminum silicate after water adsorption was placed in a constant temperature and humidity chamber with a relative humidity of 50%, and the changes in mass were investigated when the amorphous aluminum silicate was left at various temperatures for 0.1 hour. The lowest temperature at which the mass reduction rate for amorphous aluminum silicate after water adsorption was 30% was defined as the water removal temperature, and it was found to be 70° C.

### [3. Manufacture of Heater Element Assembly]

Heater elements according to the following Examples and Comparative Examples were manufactured in quantities necessary for various analyzes and tests.

### Example 1

A paste made by mixing aluminum powder with a binder resin was applied to both end surfaces (first end surface 101a and second end surface 101b) of the honeycomb structure portion, and baked. A pair of electrode layers (first electrode layer 102a and second electrode layer 102b) were joined respectively by baking (volume resistivity at 25° C.: 2.0×10⁻⁷ Ω·cm).

Of the area of the first end surface 101a (second end surface 101b) excluding the opening of the cells 104 (that is, the partition wall portions and outer peripheral wall portion), the ratio of the area of the first end surface 101a (second end surface 101b) covered by the first electrode layer 102a (second electrode layer 102b) (coverage rate) was calculated based on the area of both, and was found to be 99%.

In addition, the average value of the entire thickness of the first electrode layer 102a (second electrode layer 102b), the average value of the thickness at portions other than the outer peripheral portion, and the average value of the thickness at the outer peripheral portion were measured by the measurement methods described above. The results are shown in Table 1.

In addition, the conditions for the first electrode layer 102a and the second electrode layer 102b are the same.

Next, a first terminal 109a and a second terminal 109b made of pure aluminum (A1050) (volume resistivity at 25° C.: 2.0×10⁻⁷ Ω·cm) in the form of a rectangular plate with a planar dimension of 100 mm×4 mm and a thickness of 1 mm were connected by soldering to the outer surfaces of the first electrode layer 102a and the second electrode layer 102b but only on the outer peripheral portions of the first end surface 101a and the second end surface 101b.

The ratio of the area that the first terminal 109a (second terminal 109b) covered the first end surface 101a (second end surface 101b) to the area of the first end surface 101a (second end surface 101b) (coverage rate) was calculated based on the area of both, and it was found to be 3%.

In addition, the conditions for the first terminal 109a and the second terminal 109b were the same.

Next, a moisture absorbent slurry was prepared by mixing amorphous aluminum silicate powder, silica powder, and solvent (water) in a mass ratio of amorphous aluminum silicate:silica solvent=95:5:100, and stirring. After applying the obtained moisture absorbent slurry to the outer surface of the first electrode layer 102a and the outer surface of the second electrode layer 102b by a brush coating method, by drying in a dryer at 190° C. for 2 hours, a first functional material-containing layer 107a and a second functional material-containing layer 107b were formed, thereby producing a heater element.

In addition, the manufacturing conditions for the first functional material-containing layer 107a and the second functional material-containing layer 107b were the same.

Of the outer surface of the first electrode layer 102a (second electrode layer 102b), the ratio of the area that the first functional material-containing layer 107a (second functional material-containing layer 107b) covered the outer surface of the first electrode layer 102a (second electrode layer 102b) with respect to the area of the portion where the first terminal 109a (second terminal 109b) was not connected (coverage rate) were calculated based on the area of both, and was found to be 95% or more. Further, the average thickness of the first functional material-containing layer 107a (second functional material-containing layer 107b) was measured by the above-mentioned measuring method, and was found to be 200 μm.

According to the procedure described above, electrical resistance measurements were performed at 12 locations on each of the first functional material-containing layer 107a and the second functional material-containing layer 107b. The electrical resistance range (minimum value to maximum value) at this time was 3.0×10⁶ to 4.0×10⁶Ω.

A cylindrical frame body 140, which had a first frame portion 141 made of resin and with an inner peripheral surface 141i having a substantially square cross section corresponding to the outer peripheral surface 103e of the outer peripheral wall 103 of the honeycomb structure portion of the heater element obtained by the above procedure, was formed by injection molding or cutting from the base material. This frame body 140 did not have a second frame portion 142 or a third frame portion 143. An annular cushioning material 150 was fitted onto the outer peripheral surface 103e of the outer peripheral wall 103 of the honeycomb structure portion of the heater element. Next, the frame body 140 was fitted onto the heater element so as to fit with the outer peripheral surface 103e of the outer peripheral wall 103 of the honeycomb structure portion and the inner peripheral surface 141i of the first frame portion 141 via the cushioning material 150, thereby assembling a heater element assembly.

Table 1 shows the following conditions for the commercially available resin used for the first frame portion 141.
R1: Type
R2: Rockwell hardness (HRR and HRM) measured in accordance with ASTM D785-2008 R15
R3: Thermal conductivity at 25° C. measured in accordance with JIS R1611: 2010
R4: Load deflection temperature specified in JIS K7191-1:2015
R5: melting point
R6: Volume resistivity at 25° C. measured in accordance with JIS C2139: 2008

Table 1 shows the material, Young's modulus, thickness displacement rate in the compression direction, and the pressure that the cushioning material received, regarding the cushioning material 150 disposed between the outer peripheral surface 103e of the outer peripheral wall 103 of the honeycomb structure portion and the inner peripheral surface 141i of the first frame portion 141. In the table, the thickness displacement rate of the compressed cushioning material in the compression direction was determined by the following formula. Displacement rate (%)=(1−Thickness of cushioning material after compression/Thickness of cushioning material before compression)×100

### Example 2, 3

A heater element assembly was assembled under the same conditions as in Example 1, except that the Rockwell hardness of the resin used for the first frame portion 141 was changed to the conditions listed in Table 1. In addition, the resin used was a commercially available one.

### Examples 4 to 7

A heater element assembly was assembled under the same conditions as in Example 1, except that a commercially available cushioning material 150 having the type and Young's modulus listed in Table 1 was used, and the cushioning material 150 was placed under the conditions listed in Table 1.

### Example 8

After assembling the heater element assembly under the same manufacturing conditions as in Example 1, a second frame portion 142 that extending from the first frame portion 141 toward the inner peripheral side of the outer peripheral contour C of the first end surface 101a and surrounding a part of the outer peripheral portion of the first end surface 101a, and a third frame portion 143 extending from the first frame portion 141 toward the inner peripheral side of the outer peripheral contour C of the second end surface 101b and surrounding a part of the outer peripheral portion of the second end surface 101b, were attached to each of the first end surface 101a and the second end surface 101b at equal intervals in the circumferential direction using an adhesive. At this time, the second frame portion 142 (third frame portion 143) were fixed so as to press the first terminal 109a (second terminal 109b) toward the first end surface 101a (second end surface 101b) via the cushioning material 129. Regarding the cushioning material 129, the material, Young's modulus, thickness displacement rate in the compression direction, and pressure the cushioning material received are shown in Table 1.

The material of the second frame portion 142 and the third frame portion 143 was the same as that of the first frame portion 141.

The width Y of the area where the second frame portion 142 (third frame portion 143) surrounded the first end surface 101a (second end surface 101b) was 5 mm.

When observing the second frame portion 142 (third frame portion 143) from the first end surface 101a (second end surface 101b) side, the ratio of the area of the second frame portion 142 (third frame portion 143) (if there were multiple second frame portions 142 (third frame portions 143), this refers to their total area.) to the area of the first end surface 101a (second end surface 101b) was 5%.

### Example 9

A heater element assembly was assembled under the same conditions as in Example 1, except that the average thickness of the first electrode layer 102a and the second electrode layer 102b at the outer peripheral portion was changed to the values listed in Table 1 using a handy roller.

### Example 10 (Radial Split Type Frame Body)

An annular cushioning material 150 was fitted onto the outer peripheral surface 103e of the outer peripheral wall 103 of the honeycomb structure portion of the heater element obtained by the same procedure as in Example 1. Next, a pair of half-split members 140a and 140b as shown in FIG. 2C (provided that their inner peripheral surface had a substantially U-shaped cross-section corresponding to the outer peripheral surface of the heater element) were connected by a connecting portion 144 from the direction perpendicular to the direction in which the flow paths of the honeycomb structure portion extended so as to sandwich the heater element with the cushioning material 150 to construct a frame body 140, thereby assembling a heater element assembly. In addition, the pair of half-split members 140a and 140b were formed by injection molding or cutting work from a base material.

The connecting portion 144 had a press-fit convex portion 144a and a concave portion 144b, and when the convex portion 144a of one half-split member 140a was pushed into the concave portion 144b of the other half-split member 140b while being elastically deformed, the connected state was maintained by the restoring force of the convex portion 144a and the concave portion 144b. At this time, a cushioning material 145 having the material, thickness displacement rate in the compression direction, and Young's modulus listed in Table 1 was sandwiched between the pair of half-split members 140a and 140b. Other conditions were the same as in Example 1 unless otherwise specified.

### Example 11 (Axial Split Type Frame Body)

An annular cushioning material 150 was fitted onto the outer peripheral surface 103e of the outer peripheral wall 103 of the honeycomb structure portion of the heater element obtained by the same procedure as in Example 1. Next, as shown in FIG. 4C, a first tubular divisional portion 140c having a first frame portion 141 and a second frame portion 142, and a second tubular divisional portion 140d having a third frame portion 143, were connected from the direction parallel to the direction in which the flow paths of the honeycomb structure portion extended, with the heater element equipped with the cushioning material 150 sandwiched therebetween to construct a frame body 140, thereby assembling a heater element assembly. At this time, the cushioning material 129 was provided between the second frame portion 142 and the outer peripheral portion of the first end surface 101a of the honeycomb structure portion, and between the third frame portion 143 and the outer peripheral portion of the second end surface 101b of the honeycomb structure portion. In addition, the first tubular divisional portion 140c and the second tubular divisional portion 140d were formed by injection molding or cutting work from a base material.

The first tubular divided portion 140c had a first inner peripheral surface 141i which was an inner peripheral surface having a substantially rectangular cross-section corresponding to the outer peripheral surface 103e of the outer peripheral wall 103 of the honeycomb structure portion, and which fitted with the outer peripheral surface 103e via a cushioning material 150; a second inner peripheral surface 141j that was connected to one end of the first inner peripheral surface 141i and whose diameter increased as the distance increased from the one end of the first inner peripheral surface 141i (inversely tapered); and a third inner peripheral surface 141k that was connected to one end of the second inner peripheral surface 141j and whose diameter decreased as the distance increased from the one end of the second inner peripheral surface 141j (tapered), in this order. Further, the outer peripheral surface of the second tubular divisional portion 140d had a first outer peripheral surface 141e that fitted with the second inner peripheral surface 141j, and a second outer peripheral surface 141f that fitted with the third inner peripheral surface 141k. The diameter of the first outer peripheral surface 141e increased as the distance increased from the second end surface 101b of the heater element 100. The second outer peripheral surface 141f was connected to one end of the first outer peripheral surface 141e, and the diameter of the second outer peripheral surface 141f decreased as the distance increased from the one end of the first outer peripheral surface 141e.

The angle θ₁ formed by the second inner peripheral surface 141j with respect to the direction in which the flow paths of the honeycomb structure portion extended was 2.0°.

The angle θ₂ formed by the third inner peripheral surface 141k with respect to the direction in which the flow paths of the honeycomb structure portion extended was 2.0°.

The materials of the first frame portion 141, second frame portion 142, and third frame portion 143 that constitute the frame body are as shown in Table 1. The conditions for the cushioning material 150 and the cushioning material 129 are as shown in Table 1. Other conditions were the same as in Example 1 unless otherwise specified.

### Comparative Example 1

A heater element assembly was assembled under the same manufacturing conditions as in Example 1, except that the inner diameter of the first frame portion was reduced by 3% and the cushioning material 150 was not used.

### [4. Properties of Heater Element Assembly]

### <Push-Out Load>

According to the measurement method described above, the load required to push out the heater element 100 from the first frame portion 141 (push-out load) was measured using a universal testing machine (68FM-30 manufactured by Instron). The results are shown in Table 1.

### <Heater Element Holding Performance>

While applying electricity by applying a voltage of 13V between the first terminal and the second terminal of the heater element assembly according to each Example and Comparative Example obtained by the above procedure, by flowing air (25° C.) through the flow paths of the heater element assembly at a flow rate of 40 L/min, heating was performed for 3 minutes, and it was confirmed that the heater element reached an average temperature of 120° C. or higher. After stopping the electricity supply, air at 25° C. was passed through at 750 L/min for 3 minutes to cool the heater element to an average temperature of 25° C. or lower. After that, by applying a voltage of 13V again and flowing air (25° C.) at a flow rate of 40 L/min into the flow paths of the heater element assembly, it was investigated whether the heater element could reach an average temperature of 120° C. or higher without being damaged or falling off the frame body when heated for 3 minutes. The holding performance of the heater element in the frame body was evaluated based on the following criteria.
Circle (◯): The heater element reached an average temperature of 120° C. or higher during reheating without being damaged or falling off the frame body.
Cross (X): The heater element was damaged or fell off from the frame body during reheating.

### <Pressure Loss>

Pressure loss between both end surfaces when air (25° C.) is flowed from one end surface at a flow rate of 750 L/min through the flow paths of the heater element assembly according to each Example and Comparative Example obtained by the above procedure was measured. The evaluation was performed based on the following criteria.
Cross (X): Pressure loss could not be measured because the heater element could not be held.
Circle (◯): Pressure loss was more than 58.2 Pa and less than 60 Pa

From the results of the above-mentioned thermal test, it is understood that by protecting the heater element with a resin frame body via a cushioning material, it is possible to obtain a heater element assembly that has a higher holding performance for the heater element than a metal frame body, that is, a heater element assembly that has a higher protection performance for the heater element. Further, from the above pressure loss measurement results, the frame body according to the Examples could minimize pressure loss when gas flows. This is because the frame body according to the Examples did not need to block the openings of the cells, and even when supplementary protection was provided for the end surface side of the heater element, the area that covered the openings of the cells could be minimized.

TABLE 1

| | Electrode layer | | | | | |
|---|---|---|---|---|---|---|
| | | | Average | | | |
| | | Average | thickness at | | | |
| | Average | thickness of first | outer | | | |
| | thickness of | electrode layer | periphery of | Frame body | | |
| | first electrode | and second | first electrode | | Second | |
| | layer and | electrode layer at | layer and | | fram | |
| | second | portions other | second | | portion, | |
| | electrode | than outer | electrode | First | third | R1: |
| | layer | peripheral portion | layer | frame | frame | Resin |
| | [μm] | [μm] | [μm] | portion | portion | type |
| Example 1 | 30 | 15 | 45 | Yes | None | Polyether |
| | | | | | | ether |
| | | | | | | ketone |
| Example 2 | 30 | 15 | 45 | Yes | None | Polyether |
| | | | | | | ether |
| | | | | | | ketone |
| Example 3 | 30 | 15 | 45 | Yes | None | Polyether |
| | | | | | | ether |
| | | | | | | ketone |
| Example 4 | 30 | 15 | 45 | Yes | None | Polyether |
| | | | | | | ether |
| | | | | | | ketone |
| Example 5 | 30 | 15 | 45 | Yes | None | Polyether |
| | | | | | | ether |
| | | | | | | ketone |
| Example 6 | 30 | 15 | 45 | Yes | None | Polyether |
| | | | | | | ether |
| | | | | | | ketone |
| Example 7 | 30 | 15 | 45 | Yes | None | Polyether |
| | | | | | | ether |
| | | | | | | ketone |
| Example 8 | 30 | 15 | 45 | Yes | Yes | Polyether |
| | | | | | | ether |
| | | | | | | ketone |
| Example 9 | 30 | 9 | 51 | Yes | None | Polyether |
| | | | | | | ether |
| | | | | | | ketone |
| Example 10 | 30 | 15 | 45 | Yes | None | Polyether |
| | | | | | | ether |
| | | | | | | ketone |
| Example 11 | 30 | 15 | 45 | Yes | Yes | Polyether |
| | | | | | | ether |
| | | | | | | ketone |
| Comparative | 30 | 15 | 45 | Yes | None | Polyether |
| Example 1 | | | | | | ether |
| | | | | | | ketone |

| | Frame body | | | | | |
|---|---|---|---|---|---|---|
| | R2: | R2: | | R4: Load | R5: | |
| | Rockwell | Rockwell | R3: Thermal | deflection | Melting | R6: Volume |
| | hardness | hardness | conductivity | temperature | point | resistivity |
| | [HRR] | [HRM] | [W/m/K] | [° C.] | [° C.] | [Ω · cm] |
| Example 1 | 100 | 90 | 0.3 | 200 | 350 | 5.0 × 10¹⁶ |
| Example 2 | 50 | 45 | 0.3 | 200 | 350 | 5.0 × 10¹⁶ |
| Example 3 | 140 | 130 | 0.3 | 200 | 350 | 5.0 × 10¹⁶ |
| Example 4 | 100 | 90 | 0.3 | 200 | 350 | 5.0 × 10¹⁶ |
| Example 5 | 100 | 90 | 0.3 | 200 | 350 | 5.0 × 10¹⁶ |
| Example 6 | 100 | 90 | 0.3 | 200 | 350 | 5.0 × 10¹⁶ |
| Example 7 | 100 | 90 | 0.3 | 200 | 350 | 5.0 × 10¹⁶ |
| Example 8 | 100 | 90 | 0.3 | 200 | 350 | 5.0 × 10¹⁶ |
| Example 9 | 100 | 90 | 0.3 | 200 | 350 | 5.0 × 10¹⁶ |
| Example 10 | 100 | 90 | 0.3 | 200 | 350 | 5.0 × 10¹⁶ |
| Example 11 | 100 | 90 | 0.3 | 200 | 350 | 5.0 × 10¹⁶ |
| Comparative | 100 | 90 | 0.3 | 200 | 350 | 5.0 × 10¹⁶ |
| Example 1 | | | | | | |

| | Cushioning material 160 | | | | Cushioning material 129 | | | |
|---|---|---|---|---|---|---|---|---|
| | | | Thickness | | | | Thickness | |
| | | | displacement | | | | displacement | |
| | | | rate of | | | | rate of | |
| | | | compressed | | | | compressed | |
| | | | cushioning | Pressure | | | cushioning | Pressure |
| | | | material in | applied to | | | material in | applied to |
| | | Young's | compression | cushioning | | Young's | compression | cushioning |
| | | modulus | direction | material | | modulus | direction | material |
| | Material | [MPa] | [%] | [MPa] | Material | [MPa] | [%] | [MPa] |
| Example 1 | Silicone | 0.1 | 30 | 0.03 | Not used | | | |
| | rubber | | | | | | | |
| | sponge | | | | | | | |
| Example 2 | Silicone | 0.1 | 30 | 0.03 | Not used | | | |
| | rubber | | | | | | | |
| | sponge | | | | | | | |
| Example 3 | Silicone | 0.1 | 30 | 0.03 | Not used | | | |
| | rubber | | | | | | | |
| | sponge | | | | | | | |
| Example 4 | Silicone | 0.06 | 30 | 0.02 | Not used | | | |
| | rubber | | | | | | | |
| | sponge | | | | | | | |
| Example 5 | Silicone | 0.25 | 30 | 0.08 | Not used | | | |
| | rubber | | | | | | | |
| | sponge | | | | | | | |
| Example 6 | Silicone | 0.1 | 30 | 0.03 | Not used | | | |
| | rubber | | | | | | | |
| | sponge | | | | | | | |
| Example 7 | Silicone | 0.1 | 30 | 0.03 | Not used | | | |
| | rubber | | | | | | | |
| | sponge | | | | | | | |
| Example 8 | Silicone | 0.1 | 30 | 0.03 | Silicone | 0.1 | 30 | 0.03 |
| | rubber | | | | rubber | | | |
| | sponge | | | | sponge | | | |
| Example 9 | Silicone | 0.1 | 30 | 0.03 | Not used | | | |
| | rubber | | | | | | | |
| | sponge | | | | | | | |
| Example 10 | Silicone | 0.1 | 30 | 0.03 | Not used | | | |
| | rubber | | | | | | | |
| | sponge | | | | | | | |
| Example 11 | Silicona | 0.1 | 30 | 0.03 | Silicone | 0.1 | 30 | 0.03 |
| | rubber | | | | rubber | | | |
| | sponge | | | | sponge | | | |
| Comparative | Not used | | | | | | | |
| Example 1 | | | | | | | | |

| | Cushioning material 145 | | | | | |
|---|---|---|---|---|---|---|
| | | Thickness | | | | |
| | | displacement | | | | |
| | | rate of | | | | |
| | | compressed | | Properties of heating element | | |
| | | cushioning | | assembly | | |
| | | material in | | | Heating | |
| | | compression | Young's | Push-out | element | |
| | | direction | modulus | load | holding | Pressure |
| | Material | [%] | [MPa] | [N] | performance | loss |
| Example 1 | Not used | | | 50 | ∘ | ∘ |
| Example 2 | Not used | | | | ∘ | ∘ |
| Example 3 | Not used | | | 50 | ∘ | ∘ |
| Example 4 | Not used | | | 50 | ∘ | ∘ |
| Example 5 | Not used | | | 50 | ∘ | ∘ |
| Example 6 | Not used | | | 20 | ∘ | ∘ |
| Example 7 | Not used | | | 70 | ∘ | ∘ |
| Example 8 | Not used | | | 50 | ∘ | ∘ |
| Example 9 | Not used | | | 50 | ∘ | ∘ |
| Example 10 | Silicone | 30 | 0.03 | 50 | ∘ | ∘ |
| | rubber | | | | | |
| | sponge | | | | | |
| Example 11 | Silicone | 0 | 0.03 | 50 | ∘ | ∘ |
| | rubber | | | | | |
| | sponge | | | | | |
| Comparative | Not used | | | 100 | x | x |
| Example 1 | | | | | | |

### DESCRIPTION OF REFERENCE NUMERALS

100: Heater element
101a: First end surface
101b: Second end surface
102a: First electrode layer
102b: Second electrode layer
103: Outer peripheral wall
103e: Outer peripheral surface
104: Cell
105a: Current-carrying component
105b: Current-carrying component
106: Partition wall
107a: First functional material-containing layer
107b: Second functional material-containing layer
109a: First terminal
109b: Second terminal
111a: Third functional material-containing layer
111b: Fourth functional material-containing layer
113: Fifth functional material-containing layer
129: Cushioning material
140: Frame body
140a: Half-split member
140b: Half-split member
140c: First tubular divisional portion
140d: Second tubular divisional portion
141: First frame portion
141e: First outer peripheral surface
141f: Second outer peripheral surface
141i: Inner peripheral surface (first inner peripheral surface)
141j: Second inner peripheral surface
141k: Third inner peripheral surface
142: Second frame portion
143: Third frame portion
144: Connecting portion
144a: Convex portion
144b: Concave portion
145: Cushioning material
150: Cushioning material
200: Power supply
300: Switching valve
310: Rotation axis
312: Opening/closing door
314: Actuator
400: Inflow pipe
500: Outflow pipe
500a: First route
500b: Second route
600: Ventilator
810: Electric wire
820: Electric wire
830: Electric wire
900: Controller
910: Power switch
1000: First air conditioning system

1. A heater element assembly, comprising a heater element, a cushioning material, and a frame body, the heater element comprising:
a honeycomb structure portion capable of generating heat when energized, comprising an outer peripheral wall; and partition walls disposed on an inner peripheral side of the outer peripheral wall partitioning a plurality of cells which form flow paths extending from a first end surface to a second end surface, the partition walls comprising a material having PTC characteristics;
a first electrode layer that covers a part or all of a surface of the partition walls forming the first end surface;
a second electrode layer that covers a part or all of a surface of the partition walls forming the second end surface;
a first terminal connected to an outer surface of the first electrode layer; and
a second terminal connected to an outer surface of the second electrode layer;
wherein the frame body comprises a first frame portion which is made of resin and has an inner peripheral surface that fits with an outer peripheral surface of the outer peripheral wall of the honeycomb structure portion via the cushioning material.

2. The heater element assembly according to claim 1, wherein the resin constituting the first frame portion has a Rockwell hardness of 150 HRR or less and/or 120 HRM or less as measured in accordance with ASTM D785-2008 R15.

3. The heater element assembly according to claim 1, wherein the resin constituting the first frame portion has a deflection temperature under load of 145° C. or higher as measured in accordance with JIS K7191-1:2015.

4. The heater element assembly according to claim 1, wherein the resin constituting the first frame portion has a melting point of 250° C. or higher.

5. The heater element assembly according to claim 1, wherein the resin constituting the first frame portion has a thermal conductivity of 0.5 W/m/K or less at 25° C. as measured in accordance with JIS R1611: 2010.

6. The heater element assembly according to claim 1, wherein the resin constituting the first frame portion has a volume resistivity of 1.0×10¹⁶ Ω·cm or more at 25° C. as measured in accordance with JIS C2139: 2008.

7. The heater element assembly according to claim 1, wherein the resin constituting the first frame portion comprises one or two selected from polyetheretherketone (PEEK) and polybutylene terephthalate (PBT).

8. The heater element assembly according to claim 1, wherein a Young's modulus of the cushioning material is 0.05 to 0.3 MPa.

9. The heater element assembly according to claim 1, wherein the cushioning material is made of silicone rubber sponge.

10. The heater element assembly according to claim 1, wherein a thickness of the cushioning material in a compression direction is 0.5 to 5.0 mm.

11. The heater element assembly according to claim 1, wherein the first end surface and the second end surface have an area of 50 to 150 cm².

12. The heater element assembly according to claim 1, comprising:
a second frame portion made of resin that extends toward an inner peripheral side from an outer peripheral contour of the first end surface and surrounds at least a part of an outer peripheral portion of the first end surface; and
a third frame portion made of resin that extends toward an inner peripheral side of an outer peripheral contour of the second end surface and surrounds at least a part of an outer peripheral portion of the second end surface.

13. The heater element assembly according to claim 12, wherein
a width of an area where the second frame portion surrounds the first end surface is 10 mm or less, expressed as a length in a direction from the outer peripheral contour of the first end surface toward a center of gravity of the first end surface; and/or
a width of an area where the third frame portion surrounds the second end surface is 10 mm or less, expressed as a length in a direction from the outer peripheral contour of the second end surface toward a center of gravity of the second end surface.

14. The heater element assembly according to claim 1, wherein the frame body is formed by connecting a pair of half-split members from a direction perpendicular to a direction in which the flow paths of the honeycomb structure portion extend.

15. The heater element assembly according to claim 14, wherein the pair of half-split members are connected by a fitting structure.

16. The heater element assembly according to claim 1, wherein the frame body is formed by connecting a first tubular divisional portion made of resin and having the first frame portion, and a second tubular divisional portion made of resin and having an outer peripheral surface that is capable of fitting with an inner peripheral surface of the first tubular divisional portion, wherein the first tubular divisional portion and the second divisional portion are connected from a direction parallel to the direction in which the flow paths of the honeycomb structure portion extend.

17. The heater element assembly according to claim 16, wherein
the inner peripheral surface of the first tubular divisional portion comprises a first inner peripheral surface that fits with the outer peripheral surface of the outer peripheral wall of the honeycomb structure portion via the cushioning material; a second inner peripheral surface that is connected to one end of the first inner peripheral surface, a diameter of the second inner peripheral surface increasing as a distance from the one end of the first inner peripheral surface increases; and a third inner peripheral surface connected to one end of the second inner peripheral surface, a diameter of the third inner peripheral surface decreasing as a distance from the one end of the second inner peripheral surface increases; and
the outer peripheral surface of the second tubular divisional portion comprises a first outer peripheral surface that fits with the second inner peripheral surface and a second outer peripheral surface that fits with the third inner peripheral surface.

18. The heater element assembly according to claim 1, wherein at least a part of the partition walls of the honeycomb structure portion and at least a part of the first electrode layer and the second electrode layer are coated with an adsorbent capable of adsorbing one or more selected from water, carbon dioxide, and organic gas components.
